(19) United States
(12) Patent Application Publication
(10) Pub. No.: US 2014/0358576 A1
(43) Pub. Date: Dec. 4, 2014

(54) SYSTEM AND METHOD FOR SURVEILLANCE AND EVALUATION OF SAFETY RISKS ASSOCIATED WITH MEDICAL INTERVENTIONS

(71) Applicant: Adverse Events, Inc., Healdsburg, CA (US)

(72) Inventors: Keith B. Hoffman, Santa Rosa, CA (US); Brian M. Overstreet, Santa Rosa, CA (US); Colin B. Erdman, Windsor, CA (US); Robert Kyle, Rancho Santa Fe, CA (US)

(21) Appl. No.: 14/279,105

(22) Filed: May 15, 2014

Related U.S. Application Data
(60) Provisional application No. 61/823,829, filed on May 15, 2013.
(60) Provisional application No. 61/876,161, filed on Sep. 10, 2013.

(51) Int. Cl. G06F 19/00

(52) U.S. Cl. CPC G06F 19/3431
USPC 705/2

(57) ABSTRACT

Certain embodiments described herein relate to systems and methods used to estimate safety-related risks associated with the use of medical products, treatments, and interventions (e.g., drugs, vaccines, medications, dietary supplements, and medical devices). More particularly, the present description relates to a method and system for estimating the risk (e.g., using a safety risk score, ranking, designation, estimate, or the like) associated with the use of an individual medical intervention.

### CROSS REFERENCE TO RELATED APPLICATIONS

Pursuant to 35 U.S.C. §119 (e), this application claims priority to the filing date of the U.S. Provisional Patent Application Ser. No. 61/823,829, filed May 15, 2013; and U.S. Provisional Patent Application Ser. No. 61/876,161, filed Sep. 10, 2013; the disclosures of which are herein incorporated by reference.

### INTRODUCTION

In order to increase the likelihood that drug, vaccine, and device efficacy signals can be detected during clinical trials, pharmaceutical, vaccine, and device developers purposefully enroll subjects who are relatively homogenous. This procedural step, while vital for achieving robust statistical descriptions of a compound, vaccine, or device's efficacy, necessarily leaves open the possibility that the test agent or device will have unexpected actions once it is used in a heterogeneous population of users.

Oftentimes, serious and life-threatening side effects that were not exposed during the screening programs become evident only after drug approval. A member of the Food and Drug Administration's (FDA's) Office of Drug Safety summed up the issue by stating: 1) “the complete adverse event profile of a drug is not known at the time of approval because of the small sample size, short duration, and limited generalizability of pre-approval clinical trials” and, 2) “since most trials exclude the elderly, children, pregnant women, patients with multiple diseases, and those on medications suspected of interaction with the study drug, the studies' participants may not be representative of the real world where the drug is eventually used” (Ahmad, 2003).

The gradual evolution of side effect profiles across numerous drug classes only after they won FDA approval serves to underscore the preceding points (examples include: severe cardiac complications from the weight management drug Meridia, (FDA, 2010) a fatal muscle-wasting syndrome from the cholesterol management drug Baycol (Charatan, 2001), and increased heart attack and stroke rates in patients taking Vioxx prescribed for osteoarthritis and joint pain (FDA, 2002)). In short, careful post-approval monitoring is vital to the ongoing drug evaluation process, and the same holds true for vaccines and medical devices.

Indeed, side effects from drugs, vaccines, and devices approved by the US Food and Drug Administration (FDA), and other national and international regulatory bodies, are a major public safety concern. For example, almost one million AE reports will be added to both the EudraVigilance (“European Medicines Agency, 2013 Annual Report on EudraVigilance for the European Parliament, the Council and the Commission,” 2014) and FAERS databases this year alone (FDA, 2012d). FAERS and a large international database (VigiBase), currently consist of seven and eight million reports, respectively.

Unfortunately, the time lag associated with the dissemination of relevant post-marketing AE information is also of significant concern. As an example for drugs, within seven years after FDA approval, only half of a drug's serious post-marketing AEs were listed in the Physician's Desk Reference, a main source of AE information for many prescribers (Lasser et al., 2002). Such delays, combined with the aforementioned limitations of the pre-approval clinical trial process reinforce the need for diligent post-marketing vigilance.

In short, all drugs, vaccines, dietary supplements, medical devices, and other medications have the potential to trigger various side effects not revealed during pre-clinical and clinical investigations. Accordingly, careful post-approval and post-marketing monitoring is vital to safety evaluation processes.

One example of safety monitoring, generally applicable to drugs and related medication products and therapies is known as “pharmacovigilance.” The WHO defines pharmacovigilance as “the science and activities relating to the detection, assessment, understanding and prevention of adverse effects or any other drug-related problem.” Additionally, the WHO defines the aims of pharmacovigilance to include; “improve patient care and safety in relation to the use of medicines and all medical and paramedical interventions; improve public health and safety in relation to the use of medicines; detect problems related to the use of medicines and communicate the findings in a timely manner; contribute to the assessment of benefit, harm, effectiveness and risk of medicines, leading to the prevention of harm and maximization of benefit; encourage the safe, rational and more effective (including cost-effective) use of medicines; and promote understanding, education and clinical training in pharmacovigilance and its effective communication to the public.

Unfortunately, unlike a carefully monitored clinical trial, once a drug, vaccine, dietary supplement, or medical device is available to consumer populations, meaningful adverse events reporting and analysis is difficult. By way of example, FDA's programs to address such issues for drugs (FAERS) (FDA, 2012a), vaccines (VAERS), dietary supplements (CAERS), and medical devices (MAUDE) consist of assembling side effect and safety-related information reports submitted by manufacturers, healthcare professionals, consumers, and lawyers into centralized computerized information databases designed to support safety surveillance programs.

FDA uses FAERS analyses to issue warnings, mandate label changes, and remove drugs from the US market after the incidence, or severity, of their side effects is determined to significantly differ from what clinical trial results previously suggested (FDA, 2012c). FAERS and other similar spontaneous reporting systems maintained by governmental and international organizations are a main resource for identifying post-marketing safety concerns (Ahmad, 2003; Bailey, Singh, Azadian, Huber, & Blum, 2010; Chen, Tsong, & Chen, 2013; Harpaz, Chase, & Friedman, 2010; Harpaz et al., 2013; Hochberg & Hauben, 2009; Moore, Furberg, Glenmullen, Maltsberger, & Singh, 2011; Moore, Glenmullen, & Furberg, 2010; Poluzzi et al., 2013; Robertson & Allison, 2009; Sakaeda, Kadoyama, & Okuno, 2011; Szarfman, Tonning, & Doraiswamy, 2004; Takarabe, Kotera, Nishimura, Goto, & Yamanishi, 2012; Tamura, Sakaeda, Kadoyama, & Okuno, 2012; Wang, Hochberg, Pearson, & Hauben, 2010; Weaver, Grenade, Kwon, & Avigan, 2009).

Many international “adverse event databases” and systems parallel FAERS's focus on adverse event information: Australia's “Therapeutic Goods Administration,” Canada's “Vigilance Adverse Reaction Online Database,” Europe's “EudraVigilance,” Japan's “Pharmaceuticals and Medical Devices Agency,” The United Kingdom's “Yellow Card Scheme,” France's “pharmacovigilance database (ANSM),” and The World Health Organization's “VigiBase,” for example.

Unfortunately, as one example of the limited use of these repositories of information, FAERS has remained inaccessible to most practicing physicians, pharmacists, and other healthcare decision makers. In fact, publicly available FAERS information can only be obtained through complicated data downloads by individuals familiar with relational databases (FDA, 2012c) or burdensome Freedom of Information Act requests. In addition, complex data mining tools used by FDA and pharmacovigilance experts are expensive and cumbersome. Such limitations severely curtail access to the FAERS database.

### SUMMARY

In view of the above-described deficiencies associated with safety-related data concerning drugs, vaccines, medications, dietary supplements, and medical devices, there is a need to solve these problems and enhance the efficient use of such data.

It is an object of the present invention to rationalize medical intervention, e.g., drug, vaccine, medication, dietary supplement, and/or medical device, safety-related information data into a structure, scoring, and ranking system amenable to efficient understanding.

Certain embodiments described herein relate to systems and methods used to estimate safety-related risks associated with the use of one or more medical interventions, e.g., products or treatment(s) (e.g., drugs, vaccines, medications, dietary supplements, and medical devices). More particularly, the present description relates to a method and system for estimating the risk (e.g., using a safety-related risk score, ranking, designation, estimate, or the like) associated with the use of a medical intervention, e.g., product or treatment.

Provided herein is a system for estimating the safety-related severity or level of risk associated with a given medical intervention, e.g., product or treatment, the system comprising: memory configured to store multiple parameters (e.g., safety-related parameters) derived from one or both pre- and post-marketing safety-related information for the given medical product or treatment; and a processor coupled to the memory and operable to execute programmed instructions stored in the memory, wherein the programmed instructions are configured to: assign an individual value for one or more of various safety-related parameters, wherein the individual value or values are based on an estimated safety-related severity, or level of risk for a patient, patient group, or population, wherein such individual value or values are summed, aggregated or combined in such a manner useful for determining a safety-related score, estimation, or ranking for the medical intervention, e.g., product or treatment.

Also provided is a method of estimating safety risks associated with the use of a medical intervention, e.g., medical product or treatment, which method includes receiving safety-related information regarding adverse events associated with a given medical intervention, e.g., drug, medication, or medical device, the method comprising: determining multiple parameters using such received data, the parameters being one or both of pre- and post-marketing information from various sources, assigning a predetermined estimate of the predictive value of received data with regard to a possible safety risks associated with a given medical intervention, e.g., drug, medication, or medical device, and determining a probability of the safety risks as a function of the multiple parameters.

Also provided is a system for estimating safety risks associated with a given medical intervention, e.g., product or treatment, which system includes a memory configured to store received data regarding the given medical intervention, e.g., drug, medication, or medical device, and a processor coupled to the memory and operable to execute programmed instructions, wherein the programmed instructions are configured to differentially weight various parameters associated with each medical intervention, e.g., drug, medication, or medical device, to produce a probability safety risk score or ranking as a function of such parameters.

A system for surveillance, ranking, scoring, and analyzing safety-related information is also described. In certain embodiments, the system comprises: at least one database containing information about adverse events, or related safety information, wherein the information includes safety-related information comprises a plurality of potential risks to a patient; a first processor configured to assign pre-determined values for one or multiple risk parameters regarding an adverse event, or related safety information; a second processor configured to determine an initial risk valuation score or ranking, a third processor configured to optionally modify the initial valuation score or ranking based on user-inputted qualifiers; and a forth processor to translate the values from processor three into a final ranking or score.

These and other features of the present teachings are set forth herein.

### BRIEF DESCRIPTION OF THE FIGURES

The skilled artisan will understand that the drawings, described below, are for illustration purposes only. The drawings are not intended to limit the scope of the present teachings in any way.

FIG. 1 is a schematic diagram showing paths of communication between a client and a server in safety scoring or ranking system containing a client, a database, and a server in accordance with an embodiment of the present invention.

FIG. 2 is a schematic diagram showing paths of communication between a client and a server in safety scoring or ranking system containing a client, a database, and a server in accordance with an embodiment of the present invention.

FIG. 3 is a flowchart showing a series of steps of a method for calculating a safety-related risk score or ranking for drugs, vaccines, medications, dietary supplements, and medical devices in accordance with an embodiment of the present invention. A series of steps will be described with respect to this method, but one of skill in the art will appreciate that these steps may be combined or additional steps may be added or subtracted.

FIG. 4 shows a map of all individual drug RxScores to their corresponding Established Pharmacologic Classes (EPC) codes.

FIG. 5 shows a map of all individual drug RxScores to their corresponding Anatomical Therapeutic Chemical (ATC) codes.

### DEFINITIONS

Before describing exemplary embodiments in greater detail, the following definitions are set forth to illustrate and define the meaning and scope of the terms used in the description.

The terms “safety assessment” and “safety-related information” are intended to refer to any information relating to the safety of a medical product or treatment, including safety-related severity, level of risk, side effect(s), unintended consequence(s), and the like relating to the use a medical product or treatment in a patient, group of patients, or population.

The term “pharmacovigilance” refers to the science and activities relating to the detection, assessment, understanding and prevention of adverse effects or any other drug-related problem.

“Medical intervention” is a comprehensive term used to refer collectively to medical products and medical treatments. The term “medical product” is intended to mean any product such as a drug, vaccine, medication, dietary supplement, or medical device, including those used in a prophylactic manner, used to treat the cause or symptoms of a medical disease, disorder, or condition. The term “medical treatment” is intended to mean any treatment, including prophylactic treatment, of a medical disease, disorder, or condition using a drug, vaccine, medication, dietary supplement, or medical device.

The terms “adverse event database” or “safety-related database” are intended to mean any international or national collection(s) of data, educational products, systems to analyze data, and/or programs to disseminate and/or catalog safety and/or adverse event information such as the US FDA's FAERS's, Australia's “Therapeutic Goods Administration,” Canada's “Vigilance Adverse Reaction Online Database,” Europe's “EudraVigilance,” Japan's “Pharmaceuticals and Medical Devices Agency,” The United Kingdom's “Yellow Card Scheme,” France's “pharmacovigilance database (ANSM),” The World Health Organization's “VigiBase,” and any related collection(s) of safety data and/or side effect information relevant to the treatment, or consequences of treatment, of a patient.

The term “combined”, in the context of combining values, is intended to include summing, aggregating, multiplying and any other mathematical procedure, including procedures that including weighting of input parameters, that results in a score, ranking, or the like, that estimates the safety of a medical product or treatment.

The terms “safety-related score” and “safety-related rank” are intended to mean any type of value that estimates the safety of a medical product or treatment. A safety-related score or rank may be quantitative or qualitative, and may be in the form of a number, letter, a word, a percentage, a ranking, etc., that allows one to compare the safety on one medical product or treatment to another.

The term “adverse event” is intended to mean any type of “side effect,” non-therapeutic event, or consequence that can be triggered by the use of a medical product or treatment, including, but not limited to, adverse consequences linked to, addiction, drug-drug interactions, special population reactions, dosing effects, etc.

The term “Outcome” is intended to mean to the state of a patient after, or during, an adverse reaction possibly linked to the use of a medical product or treatment. By way of example, this is a field that a patient, medical provider, or pharmaceutical manufacturer fills out when completing an adverse event report in a database such as FAERS. Within FAERS, there are 7 different “outcomes” as defined by the US FDA: Death, Life-threatening, Hospitalization, Disability or Permanent Damage, Congenital Anomaly/Birth Defect, Required Intervention to Prevent Permanent Impairment or Damage (Devices), and Other Serious (Important Medical Events) (FDA, 2014b).

The term “Condition Seriousness,” or sometimes “Indication Seriousness,” is intended to mean an assessment that takes into consideration the weightiness, gravity, or severity of a patient's condition, state, or circumstance. As an example, the IME lists two main categories of “Condition Seriousness” “Not Serious” and “Serious Condition” (EudraVigilance, 2013a).

The term “Adverse Event Seriousness” is intended to mean the weightiness, gravity, or severity of an adverse event experienced by a subject. By way of example, EUDRA's Important Medical Events (IME) terms are classified into one of three categories of “seriousness” based on 15,000+ preferred term classifications of adverse events. There are two categories of seriousness as defined by the IME lists: terms that would be “always” serious (Core List), and terms that “could be” serious or not according to the circumstances (Extended List) (EudraVigilance, 2013a). A third category can be used when the adverse event is missing from a case report.

The term “Event Reporter” is intended to mean the person, or entity, that submitted a given safety-related or adverse event report. By way of example, for reports submitted to FAERS, manufacturers, physicians, pharmacists, consumers, and lawyers all are separate identifications used to designate “reporter” (FDA, 2012b).

The term “Report Type” is intended to mean a designation that can indicate the origin source of the report, whether it is direct or indirect submission, whether it is expedited or non-expedited, whether it contains serious or non-serious safety-related information, and the like. By way of example, the FDA defines four different “report types” as follows: 1) reports submitted directly to the FDA; 2) reports submitted by manufacturers as expedited reports (i.e. serious or unexpected adverse reactions); 3) reports submitted by manufacturers that are non-expedited reports of serious adverse events; and 4) reports submitted by manufacturers that are non-serious, non-expedited reports for new drug products.

The term “Disproportionality” is intended to mean a mathematical value derived from an assessment of the relative frequency of, for example, an adverse event. By way of example, disproportionality measures can be used to estimate the relative frequency of an adverse event associated with the use of a drug, vaccine, dietary supplement, or medical device. The Reporting Odds Ratio (ROR) is one example of a disproportionality measure. ROR and the related PRR disproportionality measure are commonly used by safety professionals to help identify adverse events that are reported more frequently than expected. As an example, a disproportionality measure can be generated by comparing “expected” reporting frequencies of an adverse event with the amount of that same adverse event reported for a drug, vaccine, dietary supplement, or medical device. Elevated disproportionality results indicate that there is a higher than normal reporting rate for a given adverse event.

The term “Importance Weighting” is intended to mean: 1) a factoring step that assigns higher weightings to safety-related reports and/or data points provided by physicians, pharmacists, and other healthcare providers when compared to weightings assigned to safety-related reports and/or data points provided by non-healthcare providers, and 2) a factoring step that assigns higher weightings to safety-related reports and/or data points where the subject of the report or data point was only taking one medical product or treatment when compared to weightings assigned to safety-related reports and/or data points where the subject of the report or data point was taking more than one medical product or treatment.

The term “Drug Schedule” is intended to mean a classification that delineates a level of potential harm, risk, or other safety-related consideration. By way of example, the US DEA uses schedules to classify drugs into 5 categories depending on the drug's acceptable medical use and the drug's abuse or dependency potential. The abuse rate is a determinate factor in the scheduling of the drug; for example, Schedule I drugs are considered the most dangerous class of drugs with a high potential for abuse and potentially severe psychological and/or physical dependence (DEA, 2014). As the drug schedule changes, so do the noted abuse potential and other safety-related risks.

The term “Medication Guide” is intended to mean a guidance document that indicates that a regulatory body, such as the US FDA, has determined that safety-related information about, for example, a drug needs to be communicated to the public. By way of example, the FDA requires that Medication Guides be issued with prescription drugs and biological products when the agency determines that 1) certain information is necessary to prevent serious adverse effects, 2) patient decision-making should be informed by information about a known serious side effect with a product, or 3) patient adherence to directions for the use of a product are essential to its effectiveness (FDA, 2014a).

The term “Black box” or “Boxed warning” is intended to mean guidance information that indicates that a regulatory body, such as the US FDA, has determined that safety-related information about, for example, a drug needs to be communicated to the public. By way of example, the FDA assigns a boxed warning to a drug to highlight one of the following situations to prescribers: 1) there is an adverse reaction so serious in proportion to the potential benefit from the drug (e.g. fatal, life-threatening, or permanently disabling adverse reaction) that is essential that it be considered in assessing the risks and benefits of using the drug; 2) there is a serious adverse reaction that can be prevented or reduced in frequency or severity by appropriate use of the drug; or 3) FDA approved the drug with restrictions to ensure safe use because FDA concluded that the drug can be safety used only if distribution or use is restricted (FDA, 2011a). There is also the case where a boxed warning can be used to highlight warning information important to the prescriber, e.g. reduced effectiveness in certain patient populations.

### DETAILED DESCRIPTION

Before the various embodiments are described, it is to be understood that the teachings of this disclosure are not limited to the particular embodiments described, and as such can, of course, vary. It is also to be understood that the terminology used herein is for the purpose of describing particular embodiments only, and is not intended to be limiting, since the scope of the present teachings will be limited only by the appended claims.

The section headings used herein are for organizational purposes only and are not to be construed as limiting the subject matter described in any way. While the present teachings are described in conjunction with various embodiments, it is not intended that the present teachings be limited to such embodiments. On the contrary, the present teachings encompass various alternatives, modifications, and equivalents, as will be appreciated by those of skill in the art.

Where a range of values is provided, it is understood that each intervening value, to the tenth of the unit of the lower limit unless the context clearly dictates otherwise, between the upper and lower limit of that range and any other stated or intervening value in that stated range is encompassed within the present disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present teachings, the some exemplary methods and materials are now described.

The citation of any publication is for its disclosure prior to the filing date and should not be construed as an admission that the present claims are not entitled to antedate such publication by virtue of prior invention. Further, the dates of publication provided can be different from the actual publication dates which can need to be independently confirmed.

It must be noted that as used herein and in the appended claims, the singular forms “a”, “an”, and “the” include plural referents unless the context clearly dictates otherwise. It is further noted that the claims can be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which can be readily separated from or combined with the features of any of the other several embodiments without departing from the scope or spirit of the present teachings. Any recited method can be carried out in the order of events recited or in any other order that is logically possible.

One with skill in the art will appreciate that the present invention is not limited in its application to the details of construction, the arrangements of components, category selections, weightings, factors, or the steps set forth in the description or drawings herein. The invention is capable of other embodiments and of being practiced or being carried out in many different ways.

Described herein is a simple and practical procedure for the surveillance, scoring, ranking, and the like, regarding safety-related information, especially adverse event information, regarding medical interventions, e.g., drugs, vaccines, medications, dietary supplements, and medical devices.

Provided herein are a variety of computer systems and methods that can be implemented on a computer. In certain embodiments, a general-purpose computer can be configured to a functional arrangement for the methods and programs disclosed herein. The hardware architecture of such a computer is well known by a person skilled in the art, and can comprise hardware components including one or more processors (CPU), a random-access memory (RAM), a read-only memory (ROM), an internal or external data storage medium (e.g., hard disk drive, flash memory, TCP/IP layer data stream etc.). A computer system can also comprise one or more graphic boards for processing and outputting graphical information to display means. The above components can be suitably interconnected via a bus inside the computer. The computer can further comprise suitable interfaces for communicating with general-purpose external components such as a monitor, keyboard, mouse, network, storage media etc. In some embodiments, the computer can be capable of parallel processing or can be part of a network configured for parallel or distributive computing to increase the processing power for the present methods and programs. In some embodiments, the program code read out from the storage medium can be written into a memory provided in an expanded board inserted in the computer, or an expanded unit connected to the computer, and a CPU or the like provided in the expanded board or expanded unit can actually perform a part or all of the operations according to the instructions of the program code, so as to accomplish the functions described below. In other embodiments, the method can be performed using a cloud computing system. In these embodiments, the data files and the programming can be exported to a cloud or distributed computer system, which runs the program, and returns an output to the user.

A system can in certain embodiments comprise a computer that includes: a) a central processing unit; b) a main non-volatile storage drive, which can include one or more hard drives, for storing software and data, where the storage drive is controlled by disk controller; c) a system memory, e.g., high speed random-access memory (RAM), for storing system control programs, data, and application programs, including programs and data loaded from non-volatile storage drive; d) system memory can also include read-only memory (ROM); flash memory, a user interface, including one or more input or output devices, such as a mouse, a keypad, and a display; e) an optional network interface card for connecting to any wired or wireless communication network, e.g., a printer; and f) an internal bus for interconnecting the aforementioned elements of the system.

The memory of a computer system can be any device that can store information for retrieval by a processor, and can include magnetic or optical devices, or solid-state memory devices (such as volatile or non-volatile RAM or ROM), where in some instances the memory is present on or part of a non-transitory physical medium. A memory or memory unit can have more than one physical memory device of the same or different types (for example, a memory can have multiple memory devices such as multiple drives, cards, ICs, or multiple solid state memory devices or some combination of the same). With respect to computer readable media, “permanent memory” refers to memory that is permanent. Permanent memory is not erased by termination of the electrical supply to a computer or processor. Computer hard-drive ROM (i.e., ROM not used as virtual memory), CD-ROM, floppy disk, flash memory, Blue ray, and DVD are all examples of permanent memory. Random Access Memory (RAM) is an example of non-permanent (i.e., volatile) memory. A file in permanent memory can be editable and re-writable.

Operation of computer is controlled primarily by operating system, which is executed by central processing unit. The operating system can be stored in a system memory. In some embodiments, the operating system can includes a file system. In addition to an operating system, one possible implementation of the system memory includes a variety of programming files and data files for implementing the method described below. In certain cases, the programming can contain a program, where the program can be composed of various modules, and a user interface module that permits a user at user interface to manually select or change the inputs to or the parameters used by programming. The data files can include various inputs for the programming.

In certain embodiments, instructions in accordance with the method described herein can be coded onto a computer-readable medium in the form of “programming,” where the term “computer readable medium” as used herein refers to any storage or transmission medium that participates in providing instructions and/or data to a computer for execution and/or processing. Examples of storage media include a floppy disk, hard disk, optical disk, magneto-optical disk, CD-ROM, CD-R, magnetic tape, non-volatile memory card, ROM, RAM, flash memory, DVD-ROM, Blue-ray disk, solid state disk, TCP/IP, TCP and UDP data streams at all layers, and network attached storage (NAS), whether or not such devices are internal or external to the computer or storage is volatile or non-volatile. Information can be “stored” on computer readable medium, where “storing” means recording information such that it is accessible and retrievable at a later date by a computer.

The computer-implemented method described herein can be executed using programming that can be written in one or more of any number of computer programming languages. Such languages include, for example, C (Bell Labs), Java (Sun Microsystems, Inc., Santa Clara, Calif.), Visual Basic (Microsoft Corp., Redmond, Wash.), Python (Python Software Foundation), and C++ (AT&T Corp., Bedminster, N.J.), as well as any many others.

In any embodiment, data can be forwarded to a “remote location,” where “remote location,” means a location other than the location at which the program is executed. For example, a remote location could be another location (e.g., office, lab, etc.) in the same city, another location in a different city, another location in a different state, another location in a different country, etc. As such, when one item is indicated as being “remote” from another, what is meant is that the two items can be in the same room but separated, or at least in different rooms or different buildings, and can be at least one mile, ten miles, or at least one hundred miles apart. “Communicating” information references transmitting the data representing that information as electrical signals over a suitable communication channel (e.g., a private or public network). “Forwarding” an item refers to any means of getting that item from one location to the next, whether by physically transporting that item or otherwise (where that is possible) and includes, at least in the case of data, physically transporting a medium carrying the data or communicating the data. Examples of communicating media include radio or infra-red transmission channels as well as a network connection to another computer or networked device, and the internet or including email transmissions and information recorded on websites and the like.

Certain embodiments described herein relate to a computer-assisted method of processing multiple drug, vaccine, medication, dietary supplement, and medical device information sources.

The system may use a variety of safety-related information sources available at the time of forecast to determine the risk(s) associated with the use of a drug, vaccine, medication, dietary supplement, and medical device. The available information may include, for example, a multiple category matrix that differentially weighs various potential harm indicators, for example, FDA FAERS categories of: Outcome, Adverse Event Seriousness, Condition Seriousness, Event Reporter, and Report Type), or similar national or global counterparts with, optionally, existing FDA and US Drug and Enforcement Agency (DEA) guidance, or similar national or global counterparts. Additional weightings and modifiers can include a disproportionality measure, an event reporter “Importance Weighting,” and a comorbidity factor(s), or similar national or global counterparts, in this specific example. Other optional steps include additional statistics processing and ranking, scoring, or indicating with product classes or designations. The system uses a mathematical model to determine one or more parameters using the available information.

The method and system is based on compiling and weighting various safety-related components, data points, warnings, and related safety-related information with, optionally, existing rankings, for generating a surveillance indicator, a score, and/or a rank regarding the safety of a drug, vaccine, medication, dietary supplement, or medical device.

Some embodiments include implementation on a single computer, or across a network of computers, or across networks of networks of computers, for example, across a network cloud, across a local area network, on hand-held computer devices, etc. Some embodiments include implementation on computer program(s) performing one or more of the steps described herein. Such computer programs execute one or more of the steps described herein. Some embodiments of the invention include various data structures, categories, and modifiers described herein, encoded on computer-readable medium(s) and transmissible over communications network(s).

Software, web, Internet, “cloud,” or other storage and computer network implementations of the present invention could be accomplished with standard programming techniques to accomplish the various database searching, modifying, correlating, comparing, deciding, scoring, surveillance, and ranking steps.

This description illustrates exemplary embodiments in detail a method and system for evaluating risks associated with the use of a medical intervention, e.g., drug, vaccine, medication, dietary supplement, and medical device, are disclosed.

Similar embodiments and methods can be practiced according to this example with a vaccine, a medication, a dietary supplement, or a medical device. As a non-limiting example, one skilled in the art could practice such embodiments by using different, from the illustrative example below, safety-related information, safety-related information sources, weightings, categories, modifiers, inclusions, exclusions, percentages, percentiles, words, or letters, for example.

Some embodiments described herein relate to systems and methods for automating the estimation of safety-related severity or level of risk associated with the use of drugs, vaccines, medications, dietary supplements, and medical devices by integrating information from multiple databases and creating decision making advice useful to patients, healthcare providers, drug developers, investors, insurance providers, legal analysts, researchers, and policy makers.

One system calculates the safety-related severity or level of risk associated with the use of a drug, vaccine, medication, dietary supplement, or medical device for a subject from safety-related data, such as condition data, adverse event seriousness data, disproportionality measures, event reporter “Importance Weighting,” and comorbidity data, and/or similar national or global counterparts, with optional information on addiction potential, FDA warning(s), DEA warning(s), and/or similar national or global counterparts etc.

A method of estimating the safety-related severity or level of risk associated with the use of drugs, vaccines, medications, dietary supplements, and medical devices includes receiving safety-related data, such as condition data, adverse event seriousness data, disproportionality measures, and comorbidity data, and/or similar national or global counterparts, with optional information on addiction potential(s), government warnings and designations, various sub-designations found in adverse event reporting systems, and/or similar national or global counterparts, etc. associated with a given drug, vaccine, medication, dietary supplement, or medical device; optionally applying an event reporter “Importance Weighting” factor; determining multiple parameters using such received data, assigning an estimate of the predictive value of received data with regard to a possible safety risk associated with a given drug, vaccine, medication, dietary supplement, or medical device, and generating a score, ranking, or other designation regarding potential safety-related risks as a function of multiple parameters or a weighting of the multiple parameters.

A system for estimating safety-related severity or level of risk associated with a given drug, vaccine, medication, dietary supplement, or medical device includes memory configured to store received data regarding the given drug, vaccine, medication, dietary supplement, or medical device and a processor coupled to the memory and operable to execute programmed instructions, wherein the programmed instructions are configured to weigh various safety-related parameters associated with a drug, vaccine, medication, dietary supplement, or medical device to produce a safety risk score, ranking, designation, or estimate as a function of such parameters.

Certain embodiments of the present disclosure relate to the monitoring of safety-related severity, or level of risk associated with a given drug, vaccine, medication, dietary supplement, or medical device. More particularly, embodiments of the present invention relate to methods and systems that integrate information derived from multiple safety-related databases and differentially weight and/or value such information to create safety-related information output useful to healthcare providers, insurers, managed care administrators, patients, analysts, and policy makers.

Certain embodiments of the present disclosure relate generally to systems and methods for processing information regarding safety-related severity, health consequences, or level of risk associated with a given drug, vaccine, medication, dietary supplement, or medical device. More specifically, it relates to extracting safety-related severity, or level of risk data from drug, vaccine, medication, dietary supplement, and medical device information sources in a manner to support use of the data with analytic tools, scorings, and rankings.

In certain embodiments, the methods and systems comprise an automated name matching system that: i) corrects for drug, vaccine, dietary supplement, or medical devices name misspellings and incorrect data within the major fields (i.e., the inclusion of dosages or routes of administration as part of the drug name field); ii) aggregates generic and non-U.S. names under a single U.S. brand name; iii) removes duplicate case reports; and iv) identifies common adverse event and condition types within the database. Once these data cleaning steps were completed the data were used to calculate the safety scoring or ranking system disclosed herein. One version of the scoring and ranking system comprises a multi-category matrix that differentially weighs various potential harm indicators. For example, in one version of the system, a drug safety scoring and ranking was created by combining the output of over 5 million FDA FAERS case reports regarding prescription drugs with, optionally, existing FDA and Drug and Enforcement Agency (DEA) guidance.

As an example, the score and ranking calculation may incorporate a number of FAERS post-marketing adverse event datasets for each scored drug including: “Outcome,” “Adverse Event Seriousness,” “Condition/Indication Seriousness,” “Event Reporter,” and “Report Type.” To account for a given subject's existing comorbidity burden we used the van-Walraven Elixhauser index (a measurement system regarding a patient's pre-existing medical conditions) to negatively adjust the “Outcome” portion of the score. An optional event reporter “Importance Weighting” was used to adjust the weighting of individual case reports. A final FAERS-related category was the inclusion of a disproportionality measure, the Reporting Odds Ratio (ROR), regarding specific adverse events linked to a given drug. These datasets were then, optionally, combined and weighted with FDA “medication guides,” FDA “boxed warnings,” and DEA drug schedule classifications regarding abuse potential. The output of the matrix calculation for each drug was then presented on a simple 1-to-100 score.

In another example, the score and ranking calculation may incorporate a number of FAERS post-marketing adverse event datasets for each scored drug including: “Outcome,” “Adverse Event Seriousness,” “Condition/Indication Seriousness,” and “Report Type.” The “Event Reporter” field may be given an “Importance Weighting” to account for an assumed increase in reporting accuracy by healthcare professionals versus non-healthcare professionals. To account for a given subject's existing comorbidity burden the van-Walraven Elixhauser index (a measurement system regarding a patient's pre-existing medical conditions) may be used to negatively adjust the “Outcome” portion of the score. A final FAERS-related category may be the inclusion of a disproportionality measure, the Reporting Odds Ratio (ROR), regarding specific adverse events linked to a given drug. The output of the matrix calculation for each drug may then presented on a simple 1-to-100 score, where desired.

In yet another example, the score and ranking calculation may incorporate a number of FAERS post-marketing adverse event datasets for each scored drug including: “Outcome,” “Adverse Event Seriousness,” “Condition/Indication Seriousness,” and “Report Type.” The “Event Reporter” field may be modified by an “Importance Weighting” in order to 1) assign higher weightings to safety-related reports and/or data points provided by physicians, pharmacists, and other healthcare providers when compared to weightings assigned to safety-related reports and/or data points provided by non-healthcare providers, and 2) assign higher weightings to safety-related reports and/or data points where the subject of the report or data point was only taking one medical product or treatment when compared to weightings assigned to safety-related reports and/or data points where the subject of the report or data point was taking more than one medical product or treatment.

Sometimes the pre-existing disease, disorder, or condition a subject is suffering from is reported in the “Adverse Event” field of a case report. To account for this, an automated system according to embodiments of the invention may be configured to omit such instances where a pre-existing disease, disorder, or condition is listed in the “Adverse Events” field from the scoring and ranking analysis. To account for a given subject's existing comorbidity burden, the van-Walraven Elixhauser index (a measurement system regarding a patient's pre-existing medical conditions) may be employed to negatively adjust the “Outcome” portion of the score. A final category may be the inclusion of a disproportionality measure, the Reporting Odds Ratio (ROR), regarding specific adverse events linked to a given drug. The output of the matrix calculation for each drug may then be presented on a simple 1-to-100 score, where desired.

While the surveillance, scoring, and ranking systems detailed herein consist of mainly post-marketing safety information, one skilled in the art could contemplate integrating data and information taken from numerous pre-marketing sources such as clinical trial results, label insert information, scientific literature, anecdotal reports, proceedings from scientific conferences, government reports, information from compilations such as the “Physicians' Desk Reference,” databases such as www.clinicaltrials.gov, etc., as well as integrating data and information taken from other post- or pre-marketing sources.

In evaluating the potential risk associated with a given drug, vaccine, dietary supplement, medication or medical device, one may use a mathematical model to perform calculations that include one or more safety-related parameters related to the probability of an adverse event, side effect, or safety-related consequence being associated with a given drug, medication, vaccine, dietary supplement, or medical device.

For example, determining the safety risk or ranking of a drug, vaccine, medication, dietary supplement or medical device typically involves simultaneous assessment of several safety-related parameters, which can be connected by a matrix of adverse event, side effect, or safety-related consequences and/or probabilities of such consequences. Choosing these parameters, and how to weigh their individual contribution within a mathematical model may vary, as desired. Various permutations of such parameters, weights, and contributions to the scoring, or ranking may be employed, as desired.

Thus, there is a need for method and system for evaluating drug, vaccine, medication, dietary supplement, and medical device risks configured to provide a rank, score, or the like, regarding adverse events, side effects, or safety-related consequences associated with the use of drugs, vaccines, medications, or medical devices.

The present description relates generally to systems and methods used to generate rankings, scorings, and estimations regarding safety risk(s) pertaining to drugs, vaccines, medications, dietary supplements, medical devices, and so forth. More particularly, the present description relates to a method and system for evaluating drugs, vaccines, medications, dietary supplements, and medical devices by estimating the safety-related risk(s) connected to the drug, vaccine, medication, dietary supplement, or medical device.

Some embodiments alleviate the drawbacks associated with existing safety related information and databases regarding drugs, vaccines, dietary supplements, and medical devices and incorporates several additionally beneficial features.

Some embodiments provide simple approaches to surveillance, ranking, scoring, estimating, and analyzing adverse events, side effects, or safety-related consequences particularly adverse events, side effects, or safety-related consequences that occur during the post-marketing phase of a drug, vaccine, dietary supplement, or medical device.

Some embodiments relate to systems and methods for automating and simplifying adverse event, and other safety-related, information regarding drugs, vaccines, dietary supplements, and medical devices by integrating information from multiple safety-related databases and creating decision supporting advice, rankings, estimations, and scorings useful to patients, healthcare providers, drug developers, investors, researchers, analysts, manage care administrators, insurance providers, policy makers, and the like.

The first embodiment is a system for analyzing safety-related information including a client, a database, and a server. The client allows information regarding adverse events, or other safety-related information, obtained from one or more safety-related databases to be entered into the system and a ranking, scoring, classification, or other safety-related endpoint to be returned from the system. The database contains information from various safety-related databases as well as other information on drugs, vaccines, dietary supplements, and medical devices.

The server obtains safety-related information entered through the client, calculates a weighting for each safety-related risk contained in the information entered through the client, translates the weightings into a numerical value, and returns a risk ranking, or score to the client. The risk calculated by the server and returned to the client may be a score, a rank, a classification or any combination of one or all. This embodiment may further include one or more modifiers entered into the system through the client that is used by the server to modify the risk determined by the server and returned to the client.

Another embodiment is a method for calculating an overall score or ranking risk for a patient by scoring or ranking a member, select members, or all members of the drugs, vaccines, medications, dietary supplements, or medical devices the patient may be using. This method has several steps, although it will be appreciated that two or more of the following steps could be collapsed into a single step, or one or more of these steps may be broken up into even more steps, or one or more of these steps may be omitted for a given analysis. In a first step, a list of drugs, vaccines, medications, dietary supplements, or medical devices for patient is obtained. In a second step, a list of comorbidities, if any, of the patient is obtained. In a third step, individual risk scores or ranking are calculated for each of the list of drugs, vaccines, medications, dietary supplements, or medical devices that the patient is using. In a fourth step, a combined, or total, risk score or ranking regarding the patient is calculated from individual risk scores or rankings obtained for that patient. In a fifth step, the risk score or ranking for the patient is modified based on their calculated comorbidity burden. In a sixth step, all individual risk scores or rankings are analyzed to determine if there are any replacement drugs, vaccines, medications, dietary supplements, or medical devices within each respective category that might be used to replace any drugs, vaccines, medications, dietary supplements, or medical devices that have high risk scores and which the patient is currently using. The risk score or ranking for the combined drugs, vaccines, medications, dietary supplements, or medical devices categories from which the overall risk or score for the patient are then recalculated in order to assess potential changes or substitutions to the drugs, vaccines, medications, dietary supplements, or medical devices that the patient uses.

According to an exemplary embodiment, a method of evaluating safety risk associated with a drug, vaccine, medication, dietary supplement, and/or medical device includes receiving in a computerized system data regarding safety-related information on the drug, vaccine, medication, dietary supplement, and/or medical device. The method also includes determining one or more safety parameters using the received data. Parameters are based on a predetermined safety-related estimate of the predictive value of received data with regard to a possible safety risk or adverse event associated with the drug, vaccine, medication, dietary supplement, and/or medical device asset. The method also includes determining a risk score, ranking or the like regarding the safety risk(s) as a function of one of more of the parameters.

The system includes a processor linked to the computer memory, operable to execute programmed instructions, wherein the programmed instructions are configured to determine a safety-related parameter using received safety-related data from one, or multiple, sources. The parameter is based on a predetermined estimate of the safety-related risk value of received data with regard to possible safety risk(s), adverse event(s), side effect(s), or consequence(s) associated with the drug, vaccine, medication, dietary supplement, and/or medical device. The programmed instructions are also configured to determine a risk score, ranking, or the like, regarding the safety risk(s), adverse event(s), side effect(s), or consequence(s) as a function of the parameter.

According to another exemplary embodiment, a method of evaluating safety risk(s), adverse event(s), side effect(s), or consequence(s) associated with drug, vaccine, medication, dietary supplement, and/or medical device includes determining a safety-related score, ranking, or the like, parameter using information from one, or multiple, safety-related databases. The parameter is based on one or more safety-relate risk estimates with regard to a possible safety risk(s), adverse event(s), side effect(s), or consequence(s) associated with the drug, vaccine, medication, dietary supplement, and/or medical device. The method also includes determining a comorbidity parameter value, and using such a comorbidity value to modify the risk score, ranking, or the like. The method can also include various other pre- or post-marketing parameter values, and using such to modify the risk score, ranking, or the like.

The plurality of predetermined parameters are generated by sampling safety-related information data from a plurality of safety, adverse event, side effect, or consequence related databases, and by assigning risk points, scores, ranks, or the like for each of the plurality of safety, adverse event, side effect, or consequence related information data with regard to potential safety-risk(s) in order to estimate a safety score, ranking, or the like, with regard to the drug, vaccine, medication, dietary supplement, and/or medical device. The method also includes determining a probability of the safety-risk, side effect, consequence, or adverse event as a function of the parameter.

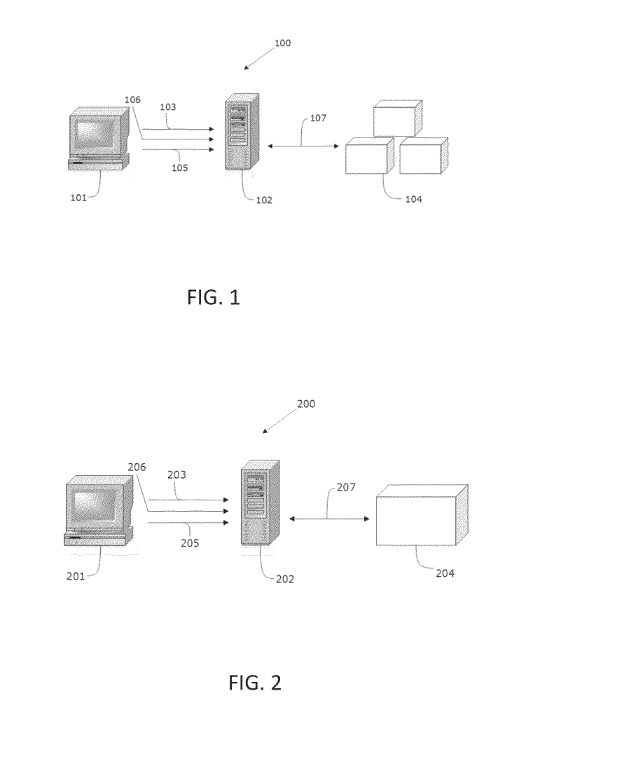

FIG. 1 is a schematic diagram showing paths of communication between a client and a server in safety scoring, ranking, or the like, system containing a client, a database, and a server in accordance with an embodiment of the present invention.

In system 100, client 101 allows a modifier to be entered into the system that will modify the safety-related risk determined by server 102 and returned to client 101. This modifier is entered via communication path 103. An exemplary modifier is an individual safety-related numerical determination regarding a risk score or ranking. Another exemplary modifier is a comorbidity numerical determination. A translation table is used to change the value of risk scores or rankings within a certain range to a specified value. If one or more databases 104 are used, then one or more modifiers are entered into the system through client 101. Communications paths 103, 105, 106, and 107 provide data communications via one or more computer networks.

FIG. 2 is a schematic diagram showing paths of communication between a client and a server in safety scoring, ranking, or like, system containing a client, a database, and a server in accordance with an embodiment of the present invention.

In system 200, client 201 allows a modifier to be entered into the system that will modify the safety-related score or rank determined by server 202 and returned to client 201. This modifier is entered via communication path 203. If one or more databases 204 are used, then one or more modifiers are entered into the system through client 201. Communications paths 203, 205, 206, and 207 provide data communications via one or more computer networks.

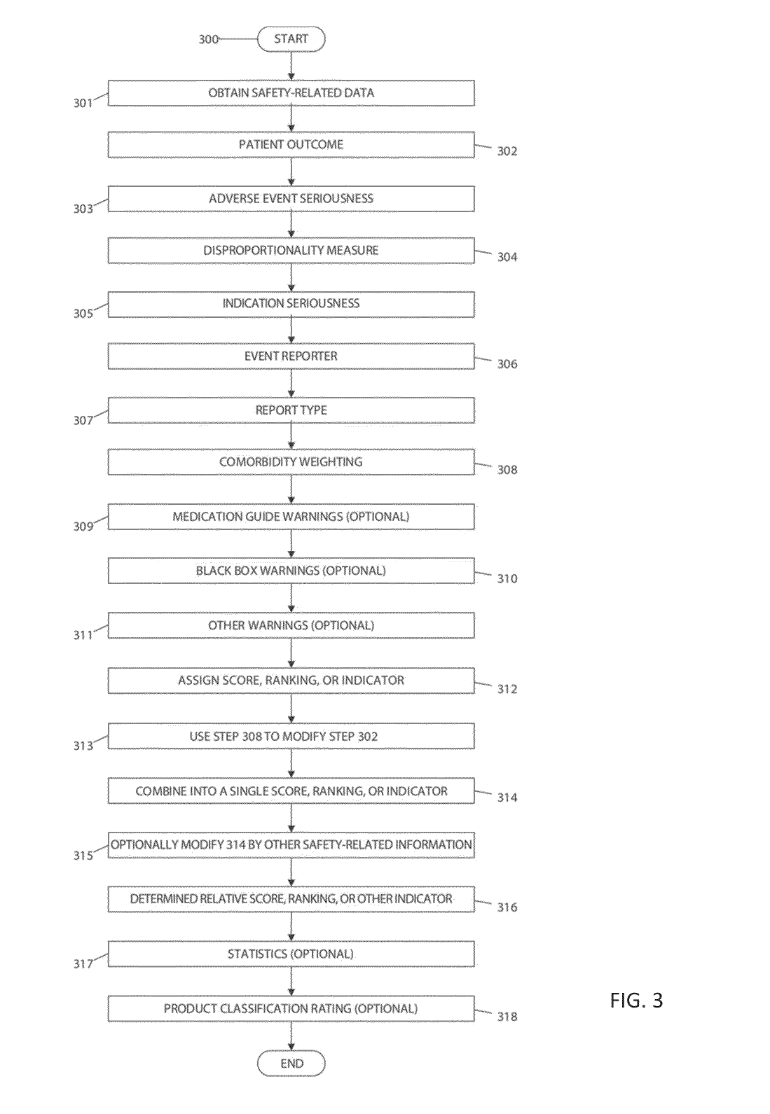

FIG. 3 is a flowchart showing a series of steps of a method for calculating a safety-related risk score or ranking for drugs, vaccines, medications, dietary supplements, and medical devices in accordance with an embodiment of the present invention. A series of steps will be described with respect to this method, but one of skill in the art will appreciate that these steps may be combined or additional steps may be added or subtracted.

In step 301 of method 300, safety, adverse event, side effect, or consequence related data are obtained from a safety-related database, such as FAERS, Eudra, VigiBase, VAERS, CAERS, or MAUDE that contains a list of safety, adverse event, side effect, or consequence related reports for individual drug(s), vaccine(s), medication(s), dietary supplement(s), or medical device(s).

In step 302, a list of patient Outcome, or global equivalent, characteristics in each case report is obtained.

In step 303, a list of Adverse Event Seriousness, or global equivalent, characteristics in each case report is obtained.

In step 304, a ROR, PRR, or related disproportionality measure is calculated for safety-related events of note in each case report.

In step 305, a list of Indication Seriousness, or global equivalent, characteristics in each case report is obtained.

In step 306, a list of Event Reporter, or global equivalent, characteristics in each case report is obtained.

In step 307, a list of Report Type, or global equivalent, characteristics in each case report is obtained.

In step 308, a list of comorbidity characteristics of the patient noted in each case report is obtained.

In step 309, a list of medication guide, or global equivalent, warnings is obtained from an FDA database.

In step 310, a list of black box guide, or global equivalent, warnings is obtained from an FDA database.

In step 311, a list of other warnings (in one embodiment this list is DEA schedule classifications) is obtained.

In step 312, one or more of the 301, 302, 303, 304, 305, 306, 307, 308, 309, 310, and 311 categories is assigned a risk score, ranking, or other numerical points or indicators that reflects its individual safety risk.

In step 313, the risk score, ranking, or other numerical points or indicators assigned to 308 are used to modify the risk score, ranking, or other numerical points or indicators assigned to 302.

In step 314, the risk score, ranking, or other numerical points for one or more of the 301, 302, 303, 304, 305, 306, 307, 308, 309, 310, and 311 categories are combined into one single score, ranking, or other numerical indicator.

In step 315, a risk score, ranking, or other numerical indicator regarding the given drug, vaccine, medication, dietary supplement, or medical device can optionally be modified by one, or multiple, other safety-related information weightings.

In step 316, the output of 314 or 315 is used to determined relative risks for a given drug, vaccine, medication, dietary supplement, or medical device by comparing the score, ranking, or other numerical indicator of the given drug, vaccine, medication, dietary supplement, or medical device with other scores, rankings, or other numerical indicators obtained by the execution of 300 for other drugs, vaccines, medications, dietary supplements, or medical devices.

Method 300 can include a number of additional steps. One step is modifying one, or multiple, risk score, ranking, or other numerical indicators based upon one, or multiple, safety-related information from other sources.

Another additional step is removing one, or multiple, categories before step 316 is executed.

Although the present invention is described in the context of a predominately post-marketing data, this invention is not to be limited thereto. It should be understood that, given the teachings in this application, those skilled in the art would understand the present invention also is applicable to other parts of the drug, vaccine, medication, dietary supplement, and/or medical device development cycles such as pre- or post-marketing clinical studies and other various databases regarding pre- and post-marketing information.

Although the foregoing embodiments have been described in some detail by way of illustration and example for purposes of clarity of understanding, it is readily apparent to those of ordinary skill in the art in light of the above teachings that certain changes and modifications can be made thereto without departing from the spirit or scope of the appended claims.

The following examples are offered by way of illustration and not by way of limitation.

### EXPERIMENTAL

### I. Example 1

### A. Methods

### 1. RxScore Calculations

RxScores were derived by combining 9 multi-weighted factors to reach a maximum of 100 total points. Points were assigned to each FAERS case report, summed, and then divided by the total number of reports for a given drug.

a. Weightings

Points assigned to each category were assigned weights based upon increasing impact and/or the amount of subjects potentially at risk for those events.

b. Category Weightings: Summary

FAERS Components

| | |
|---|---|
| Outcome | 25.65 |
| Event Seriousness | 20.03 |
| Disproportionality Measure | 14.98 |
| Condition Seriousness | 8.68 |
| Event Reporter | 7.12 |
| Report Type | 4.77 |

FDA and DEA Components

| | |
|---|---|
| FDA Boxed or Med Guide Warning | 12.45 |
| DEA Schedule | 6.32 |

c. Weightings Detail

FAERS Components—We used MedDRA (MedDRA, 2013b) for the classification of both adverse events and conditions.

i. Outcome (up to 25.65 points)

In a case report with multiple outcomes, points were assigned based on the most serious outcome. For example, if the outcome was listed as “other” and “hospitalization,” we assigned 13.31 points for “hospitalization.”

| | |
|---|---|
| Death | 25.65 |
| Life Threatening | 19.72 |
| Disability | 19.56 |
| Congenital Anomaly | 15.39 |
| Required Intervention | 13.47 |
| Hospitalization | 13.31 |
| Other/Not Stated | 4.49 |

ii. Comorbidity

A modified form of the Elixhauser Comorbidity Index, the van-Walraven Elixhauser (van Walraven, Austin, Jennings, Quan, & Forster, 2009) index, was used to modify the “Outcome” point total, above, to account for the potential impact of comorbidities on a subject's reported adverse event(s). The van-Walraven-Elixhauser index is a scoring index of 2-12 regarding severity of comorbidities from hospitalized patients. The index is based upon the ICD9-CM terminology set. We mapped ICD9-CM terminologies to equivalent MedDRA Preferred Terms. The EudraVigilance MedDRA Expert Working Groups' Important Medical Events (IME) List (EudraVigilance, 2013b) was used as an index of serious adverse event terminologies. “Serious event” terms were manually mapped to ICD9-CM terminologies. A coefficient of up to 0.5 was used to reduce the “Outcome” score.

| | |
|---|---|
| 12 | Outcome*0.50 |
| 11 | Outcome*0.46 |
| 9 | Outcome*0.38 |
| 7 | Outcome*0.29 |
| 6 | Outcome*0.25 |
| 5 | Outcome*0.21 |
| 4 | Outcome*0.17 |
| 3 | Outcome*0.13 |
| 2 | Outcome*0.08 |

iii. Event Seriousness (up to 20.03 points)

The Important Medical Event Terms (IME) list, devised by EUDRA, was used to assign 15,000+ preferred term adverse events into one of three categories of “seriousness” (EudraVigilance, 2013b). In cases with multiple adverse events, points were assigned based on the most serious level of adverse event. For example, if a case had one IME Core List term, three IME Extended List terms, and ten IME Not Serious terms, we assigned a score of 20.03 based on the single IME Core List term.

| | |
|---|---|
| Serious = IME Core List | 20.03 |
| Missing/Unknown Event | 3.70 |
| Not Serious | 3.08 |

iv. Disproportionality Measure (up to 14.98 points)

The Reporting Odds Ratio (ROR) is a measure of the association reporting strength for a given drug and a given AE pair. ROR represents the ratio of incidence of the adverse event in the “exposed reports” to “unexposed reports.” Individual ROR totals were generated by using the most serious drug-adverse event pair contained in each case report. RORs and Confidence Intervals (CI) were calculated by standard formulas outlined in Bate and Evans (Bate & Evans, 2009) and Liu et al (Liu et al., 2013).

ROR variables:
the number of cases involving Drug X and Adverse Event Y
the number of cases involving Drug X and NOT Adverse Event Y
the number of cases involving NOT Drug X and Adverse Event Y
the number of cases involving NOT Drug X and NOT Adverse Event Y

| | | Not Adverse | |
|---|---|---|---|
| | Adverse Event Y | Event Y | Total |
| Using drug X | a | b | a + b |
| Not using drug X | c | d | c + d |
| Total | a + c | b + d | a + b + c + d |

$$ROR = \frac{a / b}{c / d}$$

Point distributions were as follows:

| | |
|---|---|
| More than 3000 | 14.98 |
| 1,000-2,999.99 | 15.37 |
| 900-999.99 | 14.01 |
| 800-899.99 | 13.23 |
| 500-799.99 | 12.06 |
| 300-499.99 | 10.90 |
| 150-299.99 | 10.12 |
| 75-149.99 | 8.95 |
| 45-74.99 | 7.78 |
| 25-44.99 | 7.20 |
| 13-24.99 | 5.84 |
| 7-12.99 | 4.48 |
| 3.5-6.99 | 3.70 |
| 2-3.49 | 2.34 |
| 1-1.99 | 1.17 |
| Less than 1 | 0.00 |

v. Condition Seriousness (up to 8.68 points)

The IME list was used to assign 10,000+ conditions into one of three categories of “seriousness” (EudraVigilance, 2013b). A “Not Serious” condition was scored higher than a “Serious Condition” in an attempt to offset comorbidities. In short, higher points represent situations where a patient presents with a non-serious condition but suffers an adverse event(s). If the condition is “Missing” or “Unknown,” it received 5.21 points (IME Extended List).

| | |
|---|---|
| Not Serious | 8.68 |
| Missing/Unknown Condition | 5.21 |
| Serious (IME Core List) | 1.74 |

vi. Event Reporter (up to 7.12 points)

Higher points were assigned to events reported by physicians and other healthcare providers. We did this because we believe that healthcare providers are more experienced at reporting, and are generally more accurate in assigning a causal link between a drug and an adverse event.

| | |
|---|---|
| Physician | 7.12 |
| Pharmacists | 6.05 |
| Other Health Professional | 4.63 |
| Consumer | 2.85 |
| Lawyer | 1.07 |
| No Reporter Type | 0.71 |

vii. Report Type (up to 4.77 points)

The FDA provides three types of report type classifications: Expedited, Periodic, and Direct. “A manufacturer's 15-day report is a report that contains at least one event that is not currently described in the product labeling and the patient outcome is serious. A manufacturer's Periodic report is a report that did not meet the criteria for a 15-day report. Manufacturers submit Periodic reports to FDA quarterly for newer drugs (FDA-approved for three years or less) and annually for older drugs” (FDA, 2013d). Direct reports come from someone other than the manufacturer.

| | |
|---|---|
| Expedited 15 day | 4.77 |
| Direct | 3.58 |
| Periodic | 1.59 |

### FDA and DEA Components

i. FDA “Medication Guide” and Boxed Warnings (up to 12.45 points)

Medication guides come with many prescription medicines and contain FDA-approved information meant to help avoid, or lessen, serious adverse events. Warning designations were obtained from the FDA (FDA, 2013e). A boxed warning, or “black box,” is designated by FDA to highlight drugs that have special adverse event issues, particularly those that may lead to death or serious injury (FDA, 2011b). Boxed warnings were identified via BlackBoxRx.com, FDA websites, and manual sorting from FDA-approved drug label lists (FDA, 2013a).

| | |
|---|---|
| Boxed Warning, high chance of sudden death | 12.45 |
| with large amount of patients at risk | |
| Boxed Warning, serious AEs with a large | 9.96 |
| amount of patients at risk | |
| Boxed Warning, moderately severe AEs with | 8.54 |
| moderate amount of patients at risk | |
| Boxed Warning, less severe AEs with | 7.47 |
| modest amount of patients at risk | |
| Med Guide, serious risks | 6.05 |
| Med Guide, moderate risks | 4.98 |
| Med Guide, mild risks | 2.49 |
| Med Guide, minimal risks | 1.42 |
| Boxed Warning, User Guide Error | 0.00 |

ii. DEA Schedules (up to 6.32 points)

DEA classifications consist of five schedules, based upon currently accepted medical use and the relative abuse and dependence potential of the given compound (DEA, 2013). Schedule I drugs have no currently accepted medical use in the United States and, therefore, are not included in our safety-scoring platform. Drugs listed in schedules II-V have accepted medical use(s) (DEA, 2013).

| | |
|---|---|
| Schedule II | 6.32 |
| Schedule III | 4.91 |
| Schedule IV | 2.46 |
| Schedule V | 1.05 |

### 2. Inclusion Criteria for FAERS Case Reports

Case reports that were missing or contained malformed key identification fields (Individual Safety Report number (ISR), patient number, drug sequence identification, or MedDRA® AE term) were discarded. As long as the aforementioned key identification fields were contained in a given case report, allowable missing fields included: age, gender, weight, outcome, and condition. Cases were discarded if the drug name was found to be indeterminate or if the name was determined to not represent an FDA-approved drug (e.g. dietary supplements, foods, etc). Duplicate case reports were removed. In an effort to exclude pre-approval AE case reports mistakenly logged into FAERS the date of receipt for a given case report must have occurred after the drug's FDA approval date.

### 3. Drug Name Mapping

Drug name text-mapping was accomplished as previously described by Hoffman et al. (Hoffman, Overstreet, & Doraiswamy, 2013). Drug names were normalized to RxNorm reference codes (RxNorm) using string searching and manual curation. National Drug File Reference Terminology (FDA, 2013b) was used to provide ancillary information on class and mechanism of action.

### 4. Adverse Event Coding

AE information was coded according to the Medical Dictionary for Regulatory Authorities version 16.1 (MedDRA, 2013a). “Primary suspect” designations in FAERS case reports were quantified in an attempt to restrict the analysis to those drugs directly suspected of causing the AE. (“Primary suspect” is a description chosen by the person who submitted a given case report and is their estimate of which drug, if the subject was taking more than one, was likely responsible for the observed AE).

5. Drugs included

We included all prescription drugs in FAERS that had at least 50 primary case reports submitted in the last five years.

### 6. Established Pharmacologic Classes (EPC)

EPC is a designation found in the FDA's National Drug Code file that indicates an established pharmacologic class(es), as required by the FDA's structured product labeling requirements (FDA, 2013c). We sorted all drugs into their corresponding EPC class and calculated average RxScores for each EPC.

### B. Results

### 1. RxScore Distributions and Top 20 Highest Scoring Drugs

The total number of drugs included in this example analysis was 1,105. The median RxScore was 35.15, with a mean of 36.85 and a standard deviation of 17.40. There were thirty-nine drugs with RxScores≧70, while one hundred and twenty-one drugs had scores≧60. Table 1 shows that oxycodone had the highest RxScore while methadone, acetaminophen/hydrocodone, busulfan, and fentanyl had the next four highest scores, respectively.

TABLE 1
the top 20 highest RxScores.

| | | | | Adverse | | | | |
|---|---|---|---|---|---|---|---|---|
| | | | | Event | Condition | | | |
| Compound | RxScore | EPC | Outcome | Seriousness | Seriousness | ROR | Literature** | N |
| oxycodone | 100.00 | opioid agonist | 14.81 | 14.17 | 6.53 | 5.51 | 18.8 | 26,140 |
| methadone | 95.21 | opioid agonist | 19.71 | 8.85 | 5.47 | 4.85 | 18.8 | 3,673 |
| acetaminophen/ | 91.11 | opioid agonist | 17.97 | 10.99 | 6.78 | 4.27 | 15.0 | 5,947 |
| hydrocodone | | | | | | | | |
| busulfan | 86.04 | alkylating drug | 15.73 | 14.67 | 2.52 | 7.15 | 12.5 | 2,134 |
| fentanyl (Actiq) | 85.58 | opioid agonist | 12.16 | 10.05 | 6.11 | 4.57 | 18.8 | 1,408 |
| acetaminophen/ | 84.67 | barbiturate, central | 17.81 | 11.85 | 5.96 | 3.64 | 11.2 | 406 |
| butalbital/ | | nervous system | | | | | | |
| caffeine | | stimulant, | | | | | | |
| | | methylxanthine | | | | | | |
| hydromorphone | 82.48 | opioid agonist | 13.13 | 9.28 | 6.74 | 2.69 | 18.8 | 1,726 |
| morphine | 82.45 | opioid agonist | 15.06 | 7.98 | 6.09 | 2.24 | 18.8 | 1,157 |
| coagulation factor | 81.61 | blood coagulation | 18.17 | 11.20 | 3.51 | 2.54 | 12.5 | 2,845 |
| viia, recombinant* | | factor* | | | | | | |
| bosentan | 81.44 | endothelin receptor | 16.75 | 13.93 | 2.07 | 3.81 | 11.2 | 23,637 |
| | | antagonist | | | | | | |
| fentanyl | 81.40 | opioid agonist | 11.30 | 9.28 | 6.84 | 3.78 | 18.8 | 34,833 |
| (Duragesic) | | | | | | | | |
| acetaminophen/ | 79.61 | opioid agonist | 14.43 | 8.21 | 6.39 | 2.68 | 17.5 | 2,152 |
| oxycodone | | | | | | | | |
| rosiglitazone | 79.48 | peroxisome | 12.18 | 16.03 | 3.77 | 5.53 | 12.5 | 55,372 |
| | | proliferator receptor | | | | | | |
| | | gamma agonist, | | | | | | |
| | | thiazolidinedione | | | | | | |
| fludarabine | 78.34 | nucleoside | 15.34 | 12.69 | 2.87 | 4.60 | 12.5 | 5,811 |
| | | metabolic inhibitor | | | | | | |
| tacrolimus | 78.26 | calcineurin inhibitor | 15.75 | 14.77 | 3.13 | 4.09 | 9.3 | 14,907 |
| | | immunosuppressant | | | | | | |
| metoclopramide | 78.08 | dopamine-2 receptor | 15.38 | 4.46 | 7.15 | 12.97 | 12.5 | 20,023 |
| | | antagonist | | | | | | |
| oxymorphone | 77.03 | opioid agonist | 10.33 | 6.21 | 7.87 | 3.98 | 18.8 | 1,166 |
| acetaminophen/ | 76.53 | opioid agonist | 14.89 | 8.37 | 6.61 | 2.89 | 15.0 | 1,823 |
| codeine | | | | | | | | |
| alendronate | 74.97 | bisphosphonate, | 12.58 | 15.26 | 7.02 | 6.59 | 5.0 | 43,741 |
| | | vitamin d | | | | | | |
| treprostinil | 74.68 | prostacycline | 21.63 | 15.54 | 4.00 | 6.44 | 0.0 | 2,849 |
| | | vasodilator | | | | | | |

*= Indicates a drug for which we manually assigned to an existing FDA National Drug Code (NDC) “Pharm Class” because the NDC database had no designation.
**= “Literature” represents the combined scores from FDA MedGuides, FDA boxed warnings, and DEA schedules.

### 2. Opioid Agonists and Central Nervous System Stimulants

Ten of the top twenty highest RxScores were attributed to opioid agonists. These drugs scored highly as they are often linked to drug dependence, abuse, withdrawal syndromes, overdose and death. Contributing to their scores were high associations with particularly severe events. For example, oxycodone had a disproportionality (ROR) score of 268 for the MedDRA® term “Delusional Disorder, Unspecified Type,” while methadone was linked to 144 cases of “Torsade De Pointes” (ROR 44), 1,116 cases of “Toxicity To Various Agents” (ROR 54), and 288 cases of “Respiratory Arrest” (ROR 24). In addition, fentanyl citrate (Actiq version) had 150 cases of “Accidental Drug Intake By Child” (ROR of 381).

### 3. Established Pharmacologic Classes—Weighted RxScores

As expected from the large amount of individual opioid agonist with elevated RxScores, their EPC had the highest weighted averages (table 2). Interestingly, the peroxisome proliferator receptor gamma agonist and thiazolidinediones classes, both often used as insulin sensitizers in diabetic patients, averaged almost as high as the opioids, in this example. EPCs with RxScore averages of 70 and above included: opioid agonist, peroxisome proliferator receptor gamma agonist, thiazolidinedione, and low molecular weight heparin.

TABLE 2
Weighted Scores for Established Pharmacologic Classes

| | Weighted | | | Mean | Mean | Mean | |
|---|---|---|---|---|---|---|---|
| EPC | RxScore | N (Drugs) | N (Cases) | Outcome | ES | CS | Mean ROR |
| opioid agonist | 78.70 | 32 | 106,749 | 11.63 | 6.07 | 6.56 | 3.32 |
| peroxisome proliferator receptor | 77.97 | 4 | 59,733 | 11.12 | 10.03 | 3.84 | 2.82 |
| gamma agonist | | | | | | | |
| thiazolidinedione | 75.87 | 5 | 70,936 | 11.34 | 10.15 | 3.77 | 3.07 |
| low molecular weight heparin | 72.29 | 3 | 12,611 | 13.27 | 8.95 | 5.76 | 3.11 |
| factor xa inhibitor | 67.96 | 3 | 8,898 | 12.08 | 7.13 | 5.89 | 2.94 |
| erythropoiesis-stimulating agent | 63.61 | 4 | 17,976 | 10.95 | 8.48 | 5.11 | 2.43 |
| platinum-based drug | 62.26 | 3 | 28,625 | 11.85 | 10.38 | 3.02 | 2.86 |
| atypical antipsychotic | 62.04 | 14 | 185,978 | 10.28 | 7.61 | 4.63 | 1.99 |
| bisphosphonate | 61.42 | 7 | 117,874 | 10.34 | 11.09 | 6.08 | 4.64 |
| typical antipsychotic | 61.20 | 4 | 7,344 | 11.64 | 4.69 | 5.48 | 3.08 |
| microtubule inhibitor | 60.87 | 6 | 32,764 | 11.94 | 6.36 | 3.05 | 1.78 |
| serotonin reuptake inhibitor | 60.74 | 11 | 131,023 | 10.02 | 7.10 | 6.35 | 1.88 |
| vascular endothelial growth | 60.64 | 3 | 37,752 | 10.93 | 10.10 | 3.37 | 2.46 |
| factor-directed antibody | | | | | | | |
| biguanide | 60.13 | 7 | 24,662 | 8.95 | 6.04 | 3.49 | 2.14 |
| direct thrombin inhibitor | 59.66 | 4 | 28,039 | 12.03 | 7.85 | 4.25 | 2.30 |

### II. Example 2

### A. Methods

### 1. RxScore Calculations

RxScores were derived by: 1) combining multi-weighted factors, 2) omitting the FDA warning and DEA schedules used in Example 1, and 3) subjecting the totals to a event reporter “Importance Weighting” factor to reach a maximum of 100 total points. Points were assigned to each FAERS case report, summed, and then divided by the total number of reports for a given drug.

a. Category Weightings: Summary

FAERS Components

| | |
|---|---|
| Outcome | 35 |
| Event Seriousness | 27 |
| Disproportionality Measure | 20 |
| Condition Seriousness | 12 |
| Report Type | 6 |

b. Weightings Detail
FAERS Components—We used MedDRA (MedDRA, 2013b) for the classification of both adverse events and conditions.
i. Outcome (up to 35 points)

In a case report with multiple outcomes, points were assigned based on the most serious outcome. For example, if the outcome was listed as “other” and “hospitalization,” we assigned 18.16 points for “hospitalization.”

| | |
|---|---|
| Death | 35 |
| Life Threatening | 26.91 |
| Disability | 26.69 |
| Congenital Anomaly | 21.00 |
| Required Intervention | 18.38 |
| Hospitalization | 18.16 |
| Other/Not Stated | 6.13 |

ii. Comorbidity

A modified form of the Elixhauser Comorbidity Index, the van-Walraven Elixhauser (van Walraven et al., 2009) index, was used to modify the “Outcome” point total, above, to account for the potential impact of comorbidities on a subject's reported adverse event(s). The van-Walraven-Elixhauser index is a scoring index of 2-12 regarding severity of comorbidities from hospitalized patients. The index is based upon the ICD9-CM terminology set. We mapped ICD9-CM terminologies to equivalent MedDRA Preferred Terms. The EudraVigilance MedDRA Expert Working Groups' Important Medical Events (IME) List (EudraVigilance, 2013b) was used as an index of serious adverse event terminologies. “Serious event” terms were manually mapped to ICD9-CM terminologies. A coefficient of up to 0.5 was used to reduce the “Outcome” score.

| | |
|---|---|
| 12 | Outcome*0.50 |
| 11 | Outcome*0.46 |
| 9 | Outcome*0.38 |
| 7 | Outcome*0.29 |
| 6 | Outcome*0.25 |
| 5 | Outcome*0.21 |
| 4 | Outcome*0.17 |
| 3 | Outcome*0.13 |
| 2 | Outcome*0.08 |

iii. Event Seriousness (up to 27 points)

The Important Medical Event Terms (IME) list, devised by EUDRA, was used to assign 15,000+ preferred term adverse events into one of three categories of “seriousness” (EudraVigilance, 2013b). In cases with multiple adverse events, points were assigned based on the most serious level of adverse event. For example, if a case had one IME Core List term, three IME Extended List terms, and ten IME Not Serious terms, we assigned a score of 27.00 based on the single IME Core List term.

| | |
|---|---|
| Serious = IME Core List | 27.00 |
| Missing/Unknown Event | 4.98 |
| Not Serious | 4.15 |

iv. Disproportionality Measure (up to 20 points)

The Reporting Odds Ratio (ROR) is a measure of the association reporting strength for a given drug and a given AE pair. ROR represents the ratio of incidence of the adverse event in the “exposed reports” to “unexposed reports.” Individual ROR totals were generated by using the most serious drug-adverse event pair contained in each case report. RORs and Confidence Intervals (CI) were calculated by standard formulas outlined in Bate and Evans (Bate & Evans, 2009) and Liu et al. (Liu et al., 2013).

ROR variables:
the number of cases involving Drug X and Adverse Event Y
the number of cases involving Drug X and NOT Adverse Event Y
the number of cases involving NOT Drug X and Adverse Event Y
the number of cases involving NOT Drug X and NOT Adverse Event Y

| | Adverse | Not Adverse | |
|---|---|---|---|
| | Event Y | Event Y | Total |
| Using drug X | a | b | a + b |
| Not using drug X | c | d | c + d |
| Total | a + c | b + d | a + b + c + d |

$$ROR = \frac{a / b}{c / d}$$

Point distributions were as follows:

| | |
|---|---|
| More than 150 | 20 |
| 75-149.99 | 19 |
| 45-74.99 | 17 |
| 25-44.99 | 15 |
| 13-24.99 | 12 |
| 7-12.99 | 10 |
| 3.5-6.99 | 5 |
| 2-3.49 | 3 |
| 1-1.99 | 1 |
| Less than 1 | 0 |

v. Condition Seriousness (up to 12 points)

The IME list was used to assign 10,000+ conditions into one of three categories of “seriousness” (EudraVigilance, 2013b). A “Not Serious” condition was scored higher than a “Serious Condition” in an attempt to offset comorbidities. In short, higher points represent situations where a patient presents with a non-serious condition but suffers an adverse event(s). If the condition is “Missing” or “Unknown,” it received 7.2 points (IME Extended List).

| | |
|---|---|
| Not Serious | 12 |
| Missing/Unknown Condition | 7.2 |
| Serious (IME Core List) | 2.4 |

vi. Event Reporter—Importance Weighting Factor

In this example it was assumed that: 1) physicians, pharmacists, and other healthcare providers are generally more accurate in assigning a causal linkage between a drug and an adverse event, and 2) when a subject is only taking one drug it is more likely that the reported adverse event(s) is casually related to that specific medication.

Reporter and drug quantity Weighting for each case report

| | |
|---|---|
| Health Professional and 1 drug | 2.00 |
| Health Professional and >1 drug | 1.80 |
| Non-Health Professional and 1 drug | 1.20 |
| Non-Health Professional and >1 drug | 1.00 |

### B. Results

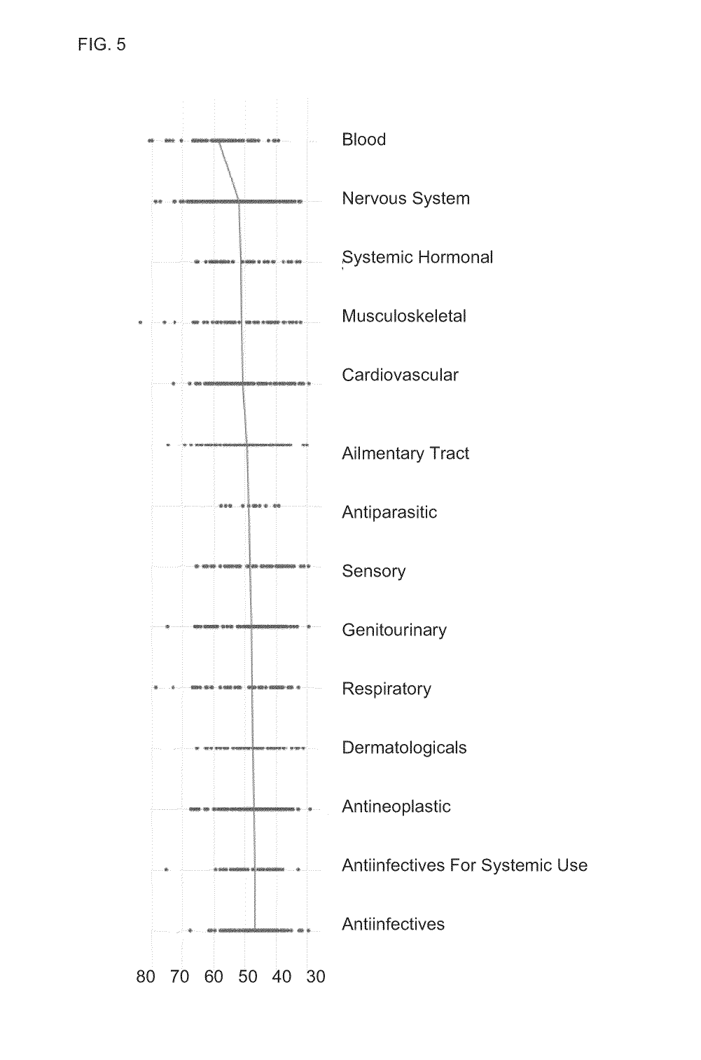

1. RxScore Distributions and Top 20 Highest Scoring Drugs The total number of drugs included in this analysis was 1,134. The median RxScore was 48.44, with a mean of 49.33 and a standard deviation of 9.29. There were twenty-five drugs with RxScores≧70, while one hundred and fifty-five drugs had scores≧60 (FIG. 5).
Table 3 shows the top 20 highest RxScores in this example.

| | | | Adverse Event | | Report | | |
|---|---|---|---|---|---|---|---|
| Compound | RxScore | Outcome | Seriousness | ROR | Priority | IW¹ | N |
| carisoprodol | 83.70 | 26.05 | 17.03 | 9.07 | 4.68 | 1.69 | 825 |
| treprostinil sodium | 80.72 | 27.93 | 22.00 | 12.45 | 5.55 | 1.37 | 2,752 |
| coagulation factor | 79.88 | 26.12 | 16.12 | 7.09 | 5.40 | 1.81 | 1,666 |
| viia, recombinant | | | | | | | |
| methamphetamine | 78.80 | 20.20 | 15.73 | 12.29 | 4.71 | 1.80 | 392 |
| hydrochloride | | | | | | | |
| acetaminophen; | 78.70 | 24.30 | 14.41 | 8.11 | 3.99 | 1.56 | 6,364 |
| hydrocodone | | | | | | | |
| bitartrate | | | | | | | |
| methadone | 77.27 | 27.60 | 11.34 | 8.73 | 4.79 | 1.44 | 3,610 |
| hydrochloride | | | | | | | |
| ibuprofen lysine | 75.91 | 16.01 | 21.97 | 9.67 | 4.78 | 1.74 | 276 |
| aztreonam | 75.34 | 22.41 | 14.58 | 5.83 | 6.00 | 1.73 | 109 |
| alteplase | 75.32 | 23.52 | 16.63 | 5.90 | 4.34 | 1.68 | 2,656 |
| tenecteplase | 75.24 | 23.36 | 16.42 | 6.00 | 3.44 | 1.61 | 554 |
| calcium chloride; | 75.18 | 23.09 | 16.85 | 4.17 | 5.69 | 1.63 | 31,517 |
| dextrose; | | | | | | | |
| magnesium | | | | | | | |
| chloride; sodium | | | | | | | |
| chloride; sodium | | | | | | | |
| lactate | | | | | | | |
| dinoprostone | 74.95 | 19.09 | 15.66 | 10.62 | 4.65 | 1.60 | 319 |
| nitisinone | 74.78 | 23.09 | 15.20 | 5.32 | 5.47 | 1.58 | 171 |
| alpha-1-proteinase | 74.23 | 23.45 | 14.24 | 5.32 | 5.54 | 1.49 | 223 |
| inhibitor (human) | | | | | | | |
| icodextrin | 73.08 | 22.03 | 15.16 | 5.55 | 5.51 | 1.66 | 1,933 |
| epinephrine | 73.02 | 21.03 | 4.69 | 16.91 | 5.86 | 1.63 | 220 |
| injection | | | | | | | |
| alprazolam | 72.84 | 21.02 | 13.30 | 6.40 | 4.61 | 1.50 | 8,976 |
| verapamil | 72.76 | 21.73 | 13.01 | 6.10 | 4.61 | 1.57 | 3,059 |
| hydrochloride | | | | | | | |
| temazepam | 72.69 | 22.08 | 12.79 | 5.17 | 3.90 | 1.57 | 831 |
| cyclobenzaprine | 72.46 | 22.45 | 12.25 | 6.09 | 4.02 | 1.57 | 1,010 |
| hydrochloride | | | | | | | |

¹Importance Weighting

### 2. Established Pharmacologic Classes (EPC)—Weighted RxScores

TABLE 4

| | Weighted | | | Mean | | | Mean |
|---|---|---|---|---|---|---|---|
| EPC | RxScore | N (Drugs) | N (Cases) | Outcome | Mean ES | Mean CS | ROR |
| calculi dissolution agent | 69.56 | 3 | 33,545 | 20.13 | 16.11 | 12.00 | 3.61 |
| blood coagulation factor | 62.22 | 10 | 36,867 | 16.33 | 11.25 | 12.00 | 5.06 |
| opioid agonist | 60.52 | 31 | 106,615 | 15.87 | 9.25 | 12.00 | 5.58 |
| anti-coagulant | 58.91 | 6 | 37,063 | 16.60 | 11.36 | 7.20 | 6.90 |
| peroxisome proliferator | 53.92 | 5 | 59,370 | 14.27 | 12.48 | 2.40 | 5.95 |
| receptor gamma agonist | | | | | | | |
| thiazolidinedione | 53.92 | 5 | 59,370 | 14.27 | 12.48 | 2.40 | 5.95 |
| nucleoside metabolic | 52.70 | 12 | 44,452 | 15.17 | 11.87 | 2.40 | 5.47 |
| inhibitor | | | | | | | |
| angiotensin 2 receptor | 52.34 | 18 | 45,377 | 14.10 | 8.11 | 10.40 | 2.10 |
| blocker | | | | | | | |
| phosphodiesterase 5 | 51.55 | 6 | 35,956 | 12.04 | 8.77 | 8.80 | 5.79 |
| inhibitor | | | | | | | |
| vascular endothelial | 51.52 | 4 | 30,655 | 12.19 | 13.00 | 2.40 | 5.10 |
| growth factor-directed | | | | | | | |
| antibody | | | | | | | |
| calcineurin inhibitor | 51.28 | 8 | 32,096 | 13.60 | 9.97 | 4.80 | 5.85 |
| immunosuppressant | | | | | | | |
| dihydropyridine calcium | 50.12 | 16 | 35,871 | 13.52 | 7.65 | 9.00 | 2.96 |
| channel blocker | | | | | | | |
| bisphosphonate | 49.69 | 7 | 73,291 | 12.25 | 10.88 | 2.40 | 6.69 |
| mood stabilizer | 48.57 | 9 | 55,347 | 13.38 | 9.86 | 3.47 | 4.88 |
| insulin analog | 47.51 | 7 | 33,243 | 11.99 | 8.95 | 2.40 | 6.91 |

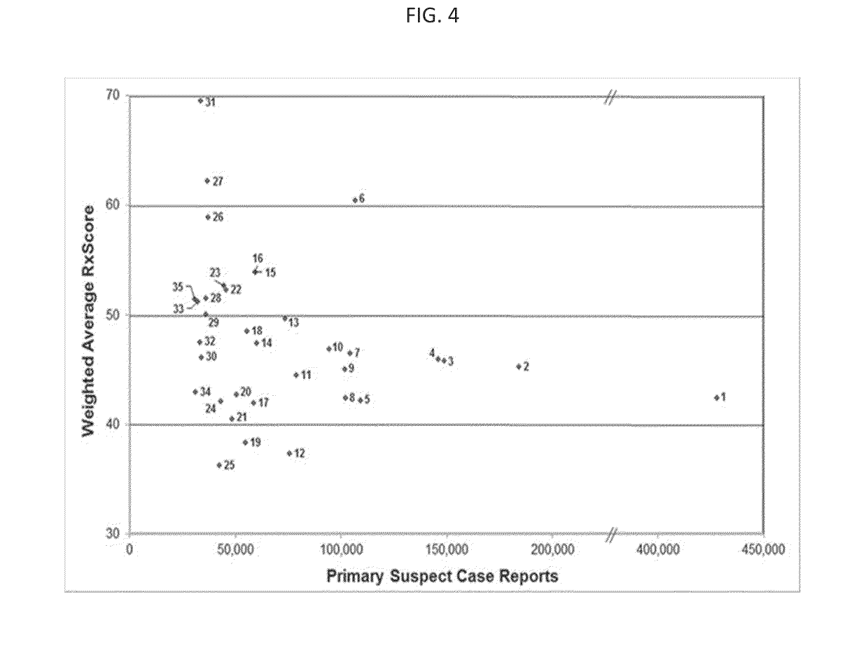

FIG. 4 shows the distribution of 35 weighted average RxScores for each EPC that comprised ≧3 individual compounds with ≧30,000 primary suspect cases reports in FAERS over the time period studied. We designated the X-axis as the number of adverse event cases reported to FDA, while the Y-axis is weighted RxScore averages.

### Legend to FIG. 4:

| | EPC |
|---|---|
| 1 | Tumor Necrosis Factor Blocker |
| 2 | Progestin |
| 3 | Atypical Antipsychotic |
| 4 | Anti-epileptic Agent |
| 5 | HMG-CoA Reductase Inhibitor |
| 6 | Opioid Agonist |
| 7 | Recombinant Human Interferon beta |
| 8 | Estrogen |
| 9 | Serotonin Reuptake Inhibitor |
| 10 | Kinase Inhibitor |
| 11 | Corticosteroid |
| 12 | Progestin-containing Intrauterine Device |
| 13 | Bisphosphonate |
| 14 | Nonsteroidal Anti-inflammatory Drug |
| 15 | Peroxisome Proliferator Receptor gamma Agonist |
| 16 | Thiazolidinedione |
| 17 | Proton Pump Inhibitor |
| 18 | Mood Stabilizer |
| 19 | GLP-1 Receptor Agonist |
| 20 | beta2-Adrenergic Agonist |
| 21 | Serotonin and Norepinephrine Reuptake Inhibitor |
| 22 | Angiotensin 2 Receptor Blocker |
| 23 | Nucleoside Metabolic Inhibitor |
| 24 | Quinolone Antimicrobial |
| 25 | Nicotinic Acid |
| 26 | Anti-coagulant |
| 27 | Blood Coagulation Factor |
| 28 | Phosphodiesterase 5 Inhibitor |
| 29 | Dihydropyridine Calcium Channel Blocker |
| 30 | Anticholinergic |
| 31 | Calculi Dissolution Agent |
| 32 | Insulin Analog |
| 33 | Calcineurin Inhibitor Immunosuppressant |
| 34 | Retinoid |
| 35 | Vascular Endothelial Growth Factor-directed Antibody |

FIG. 5 shows individual drug RxScores were mapped to theft corresponding Anatomical Therapeutic Chemical (ATC) codes. RxScores are noted on the Y-axis. Aggregated ATC groups have theft individual RxScores plotted in a vertical line with the lowest median group RxScores to the left and the highest to the right. A line was used to mark the median RxScore for each ATC group.

3. Examples of within-Drug Class Differences

TABLE 5
Bisphosphonates:

| | | | Adverse Event | | Condition | Report | | |
|---|---|---|---|---|---|---|---|---|
| Compound | RxScore | Outcome | Seriousness | ROR | Seriousness | Priority | IW¹ | N |
| alendronate sodium | 57.70 | 15.75 | 13.24 | 8.46 | 2.40 | 4.08 | 1.45 | 24,676 |
| (and cholecalciferol) | | | | | | | | |
| zoledronic acid | 53.50 | 7.55 | 14.61 | 10.08 | 2.40 | 5.57 | 1.69 | 17,162 |
| (Zometa) | | | | | | | | |
| zoledronic acid | 53.23 | 16.89 | 12.33 | 3.53 | 2.40 | 5.31 | 1.51 | 13,931 |
| (Reclast) | | | | | | | | |
| pamidronate disodium | 51.86 | 6.73 | 12.75 | 11.49 | 2.40 | 5.01 | 1.58 | 4,208 |
| risedronate sodium | 46.13 | 13.15 | 8.19 | 4.82 | 2.40 | 3.46 | 1.52 | 3,450 |
| (Actonel) | | | | | | | | |
| ibandronate sodium | 45.79 | 13.02 | 10.42 | 3.13 | 2.40 | 3.81 | 1.41 | 9,805 |
| risedronate sodium | 39.63 | 12.68 | 4.60 | 5.34 | 2.40 | 1.63 | 1.44 | 59 |
| (Atelvia) | | | | | | | | |

¹Importance Weighting

TABLE 6
Anti-epileptic medications:

| | | | Adverse Event | | Report | | |
|---|---|---|---|---|---|---|---|
| Compound | RxScore | Outcome | Seriousness | ROR | Priority | IW¹ | N |
| valproic acid | 54.78 | 16.41 | 12.54 | 5.34 | 5.17 | 1.49 | 5,345 |
| levetiracetam | 52.79 | 12.68 | 13.68 | 4.99 | 4.90 | 1.52 | 131 |
| vigabatrin | 51.42 | 13.81 | 13.32 | 4.80 | 3.66 | 1.61 | 907 |
| clonazepam | 51.36 | 15.34 | 11.38 | 3.43 | 3.87 | 1.43 | 5,255 |
| levetiracetam | 50.58 | 12.51 | 12.65 | 4.79 | 4.82 | 1.59 | 8,371 |
| carbamazepine | 50.22 | 13.84 | 11.65 | 4.49 | 5.01 | 1.53 | 9,670 |
| zonisamide | 49.83 | 13.71 | 11.03 | 4.73 | 4.21 | 1.58 | 1,915 |
| valproate sodium | 48.83 | 13.09 | 10.26 | 5.64 | 4.89 | 1.59 | 2,908 |
| tiagabine hydrochloride | 48.70 | 12.04 | 10.82 | 6.41 | 2.96 | 1.39 | 619 |
| carbamazepine | 47.67 | 12.55 | 10.63 | 4.67 | 3.80 | 1.41 | 281 |
| topiramate | 47.54 | 11.96 | 11.28 | 4.29 | 4.14 | 1.58 | 8,324 |
| perampanel | 47.40 | 14.67 | 7.92 | 3.53 | 5.81 | 1.37 | 93 |
| fosphenytoin sodium | 46.69 | 15.85 | 8.16 | 5.09 | 2.62 | 1.51 | 454 |
| oxcarbazepine | 45.64 | 12.20 | 9.92 | 4.05 | 4.21 | 1.50 | 4,787 |
| lacosamide | 45.32 | 10.94 | 10.86 | 3.89 | 3.93 | 1.63 | 2,231 |
| phenytoin sodium | 44.47 | 12.65 | 8.38 | 5.12 | 3.20 | 1.43 | 10,382 |
| carbamazepine | 44.16 | 11.75 | 9.29 | 3.19 | 4.74 | 1.35 | 683 |
| felbamate | 43.92 | 14.26 | 7.72 | 2.81 | 3.29 | 1.38 | 204 |
| rufinamide | 43.21 | 13.47 | 6.86 | 2.94 | 4.42 | 1.70 | 106 |
| gabapentin | 43.00 | 11.51 | 9.67 | 2.86 | 3.33 | 1.39 | 16,912 |
| gabapentin enacarbil | 42.19 | 7.53 | 4.67 | 2.64 | 1.73 | 1.33 | 170 |
| primidone | 42.07 | 10.86 | 8.70 | 3.59 | 2.60 | 1.32 | 522 |
| lamotrigine | 42.04 | 10.41 | 8.89 | 3.57 | 2.67 | 1.32 | 23,685 |
| divalproex sodium | 41.09 | 11.14 | 8.51 | 3.85 | 1.95 | 1.42 | 8,999 |
| ethosuximide | 41.01 | 10.64 | 7.71 | 2.92 | 4.46 | 1.52 | 238 |
| pregabalin | 36.30 | 8.25 | 7.13 | 2.21 | 2.77 | 1.47 | 32,464 |

¹Importance Weighting

### 4. RxScore Component Scores

We tabulated drugs with the highest point totals for individual components of the RxScore.

TABLE 7
20 Drugs with highest Outcome scores.

| Compound | EPC | Outcome |
|---|---|---|
| treprostinil sodium | Prostacycline | 27.93 |
| | Vasodilator | |
| methadone hydrochloride | Opioid Agonist | 27.60 |
| coagulation factor | Blood Coagulation | 26.12 |
| viia, recombinant | Factor | |
| carisoprodol | Muscle Relaxant | 26.05 |
| pomalidomide | Thalidomide Analog | 25.31 |
| acetaminophen; | Methylxanthine; | 24.85 |
| butalbital; | Central Nervous | |
| caffeine | System Stimulant; | |
| | Barbiturate | |
| acetaminophen; | Opioid Agonist | 24.30 |
| hydrocodone | | |
| bitartrate | | |
| clozapine | Atypical Antipsychotic | 23.55 |
| alteplase | Tissue Plasminogen | 23.52 |
| | Activator* | |
| alpha-1-proteinase | Human alpha-1 | 23.45 |
| inhibitor (human) | Proteinase Inhibitor | |
| tenecteplase | Tissue Plasminogen | 23.36 |
| | Activator* | |
| clofarabine | Nucleoside Metabolic | 23.27 |
| | Inhibitor | |
| nitisinone | Hydroxyphenyl-Pyruvate | 23.09 |
| | Dioxygenase Inhibitor | |
| calcium chloride; | Calculi Dissolution Agent; | 23.09 |
| dextrose; magnesium | Blood Coagulation Factor | |
| chloride; sodium | | |
| chloride; sodium | | |
| lactate (Dianeal) | | |
| bosentan | Endothelin Receptor | 22.96 |
| | Antagonist | |
| carfilzomib | Proteasome Inhibitor | 22.81 |
| azacitidine | Nucleoside Metabolic | 22.72 |
| | Inhibitor | |
| thalidomide | Treatment of Erythema | 22.64 |
| | Nodosum Leprosum (ENL)* | |
| micafungin sodium | Echinocandin Antifungal | 22.48 |
| cyclobenzaprine | Muscle Relaxant | 22.45 |
| hydrochloride | | |

TABLE 8
20 Drugs with the highest Adverse Event Seriousness scores.

| | | Adverse Event |
|---|---|---|
| Compound | EPC | Seriousness |
| treprostinil sodium | Prostacycline Vasodilator | 22.00 |
| ibuprofen lysine | Nonsteroidal Anti- | 21.97 |
| | inflammatory Drug | |
| conjugated estrogens; | Progestin; Estrogen | 21.02 |
| medroxyprogesterone | | |
| acetate | | |
| estradiol | Estrogen | 20.16 |
| medroxyprogesterone | Progestin | 19.89 |
| acetate | | |
| nitric oxide | Vasodilator | 19.58 |
| erlotinib | Kinase Inhibitor | 18.95 |
| hydrochloride | | |
| gadodiamide | Paramagnetic Contrast Agent | 17.43 |
| thalidomide | Treatment of Erythema | 17.30 |
| | Nodosum Leprosum (ENL)* | |
| ranibizumab | Vascular Endothelial Growth | 17.19 |
| | Factor-directed Antibody | |
| acetaminophen; | Methylxanthine; Central | 17.16 |
| butalbital; | Nervous System Stimulant; | |
| caffeine | Barbiturate | |
| carisoprodol | Muscle Relaxant | 17.03 |
| bosentan | Endothelin Receptor | 16.98 |
| | Antagonist | |
| calcium chloride; | Calculi Dissolution Agent; | 16.85 |
| dextrose; magnesium | Blood Coagulation Factor | |
| chloride; sodium | | |
| chloride; sodium | | |
| lactate | | |
| alteplase | Tissue Plasminogen Activator* | 16.63 |
| tenecteplase | Tissue Plasminogen Activator* | 16.42 |
| calcium chloride; | Calculi Dissolution Agent; | 16.32 |
| dextrose; magnesium | Blood Coagulation Factor | |
| chloride; sodium | | |
| chloride; sodium | | |
| lactate | | |
| mifepristone | Progestin Antagonist | 16.31 |
| clozapine | Atypical Antipsychotic | 16.28 |
| rosiglitazone | Thiazolidinedione; | 16.27 |
| maleate | Peroxisome Proliferator | |
| | Receptor gamma Agonist | |

TABLE 9
the top 20 drugs with the highest Disproportionality scores.

| Compound | EPC | ROR |
|---|---|---|
| epinephrine injection | Catecholamine; beta-Adrenergic | 16.91 |
| (Twinject) | Agonist; alpha-Adrenergic Agonist | |
| penicillin g potassium | Penicillin-class Antibacterial | 15.14 |
| sodium iodide i-131 | Radioactive Therapeutic Agent | 14.71 |
| ocriplasmin | Proteolytic Enzyme* | 14.20 |
| conjugated estrogens; | Progestin; Estrogen | 13.87 |
| medroxyprogesterone | | |
| acetate | | |
| methylphenidate | Central Nervous System Stimulant | 13.69 |
| azithromycin | Macrolide Antimicrobial | 13.60 |
| morphine sulfate | Opioid Agonist | 13.37 |
| estradiol | Estrogen | 13.26 |
| medroxyprogesterone | Progestin | 12.89 |
| acetate | | |
| alcaftadine | Histamine-1 Receptor Antagonist | 12.53 |
| treprostinil sodium | Prostacycline Vasodilator | 12.45 |
| retapamulin | Pleuromutilin Antibacterial | 12.35 |
| methamphetamine | Central Nervous System Stimulant; | 12.29 |
| hydrochloride | Amphetamine Anorectic | |
| phentermine | Sympathomimetic Amine Anorectic | 12.22 |
| hydroxyprogesterone | Progestin | 12.09 |
| caproate | | |
| mifepristone | Progestin Antagonist | 12.02 |
| tuberculin purified | Tuberculosis Skin Test; | 11.93 |
| protein derivative | Skin Test Antigen | |
| autologous cultured | Autologous Cultured Cell | 11.91 |
| chondrocytes | | |
| methadone hydrochloride | Opioid Agonist | 11.75 |

Healthcare providers need more safety tools that reflect a given drug, vaccine, medication, dietary supplement, or medical device effects in heterogeneous, real-world, populations. We believe the development of ranking and scoring methods such as those disclosed above, meet that need.

A method and system for rationalizing safety-related data regarding drugs, vaccines, medications, dietary supplements, and medical devices has been described herein. These and other variations, which will be appreciated by those skilled in the art, are within the intended scope of this invention as claimed below.

The surveillance, scoring, and ranking systems disclosed here are based predominately, or solely in some embodiments, on post-marketing safety evidence, and are intended to provide an important addition to safety conversations between healthcare providers, insurers, managed care administrators, and patients. It is our belief that there is no better way to determine the safety of a given drug, vaccine, medication, dietary supplement, or medical device than by reviewing all the information available, from pre- to post-marketing. As with all aspects related to human health, however, no one element should be considered on its own, but instead be viewed as a component in the overall safety picture.

Systems and methods in accordance with embodiments of the present invention disclosed herein can advantageously improve the estimation of risks associated with the use of a drug, vaccine, medication, dietary supplement, or medical device are disclosed. Such systems and methods also provide customizable modules, tools, and inputs that can be used to explore different safety-related analysis.

### III. References

The following citations have been referenced throughout the foregoing specification:
Ahmad, S. R. (2003). Adverse drug event monitoring at the Food and Drug Administration. J Gen Intern Med, 18(1), 57-60.
Bailey, S., Singh, A., Azadian, R., Huber, P., & Blum, M. (2010). Prospective data mining of six products in the US FDA Adverse Event Reporting System: disposition of events identified and impact on product safety profiles. Drug Saf, 33(2), 139-146. doi: 10.2165/11319000-000000000-00000
Bate, A., & Evans, S. J. (2009). Quantitative signal detection using spontaneous ADR reporting. Pharmacoepidemiol Drug Saf, 18(6), 427-436. doi: 10.1002/pds.1742
Charatan, F. (2001). Bayer decides to withdraw cholesterol lowering drug. Bmj, 323(7309), 359.
Chen, H. C., Tsong, Y., & Chen, J. J. (2013). Data mining for signal detection of adverse event safety data. J Biopharm Stat, 23(1), 146-160. doi: 10.1080/10543406.2013.735780
DEA. (2013). US Department of Justice Drug Enforcement Administration, Office of Diversion Control. Controlled Substance Schedules. Retrieved August 2013, from http://www.deadiversion.usdoj.gov/schedules/index.html
DEA. (2014). Drug Scheduling, from http://www.justice.gov/dea/druginfo/ds.shtml
EudraVigilance. (2013a). Expert Working Group: Important Medical Event Terms (IME) list. Retrieved January 2014, from http://eudravigilance.ema.europa.eu/human/textforlME.asp
EudraVigilance. (2013b). Important Medical Event Terms (IME) list (Expert Working Group). Retrieved August 2013, from http://eudravigilance.ema.europa.eu/human/textforlME.asp
European Medicines Agency, 2013 Annual Report on EudraVigilance for the European Parliament, the Council and the Commission. (2014). from http://www.ema/europa.ed/docs/en_GB/document_librarby/Report/2014/04/WC500165780.pdf
FDA. (2002). Safety Information: Vioxx (rofecoxib) May 2002. Retrieved August 2013, from http://www.fda.gov/Safety/MedWatch/SafetyInformation/SafetyAlertsforHumanMedicalProducts/ucm154520.htm
FDA. (2010). Follow-Up to the November 2009 Early Communication about an Ongoing Safety Review of Sibutramine, Marketed as Meridia. Jan. 22, 2010. Retrieved August 2013, from http://www.fda.gov/Drucs/DrugSafety/PostmarketDrucSafetyInformationfor PatientsandProviders/DrugSafetyInformationforHeathcareProfessionals/ucm98206.htm
FDA. (2011a). Guidance for Industry: Warnings and Precautions, Contraindications, and Boxed Warning Sections of Labeling for Human Prescription Drug and Biological Products—Content and Format., from http://www.fda.gov/downloads/Drugs/Guidances/ucm075096.pdf
FDA. (2011b). Guidance for Industry: Warnings and Precautions, Contraindications, and Boxed Warning Sections of Labeling for Human Prescription Drug and Biological Products—Content and Format. October 2011. Retrieved August 2013, from http://www.fda.gov/downloads/Drugs/GuidanceComplianceRegulatoryInformation/Guidances/ucm075096.pdf
FDA. (2012a). Adverse Event Reporting System (FAERS) (formerly AERS). Retrieved January 2014, from http://www.fda.gov/drugs/guidancecomplianceregulatoryinformation/surveillance/adversedrugeffects/default.htm
FDA. (2012b). FAERS Reporting by Healthcare Providers and Consumers by Year.
FDA. (2012c). FDA Adverse Event Reporting System (FAERS) (formerly AERS). from http://www.fda.gov/drugs/guidancecomplianceregulatoryinformation/surveillance/adversedrugeffects/default.htm
FDA. (2012d). Reports Received and Reports Entered into AERS by Year. Retrieved January 2014, from http://www.fda.gov/Drugs/GuidanceComplianceRegulatorInformation/Surveillance/AdverseDrugEffects/ucm070434.htm
FDA. (2013a). FDA Online Label Repository. Retrieved August 2013, from http://labels/fda.gov/
FDA. (2013b). Pharmacological Class: National Drug File Reference Terminology. Retrieved January 2014, from http://www.fda.gov/ForIndustry/DataStandards/StructuredProductLabeling/ucm162549.htm

FDA. (2013c). Pharmacological Class: National Drug File Reference Terminology. Apr. 2, 2013. Retrieved August 2013, from http://www.fda.gov/ForIndustry/DataStandards/StructuredProductLabeling/ucm162549.htm
FDA. (2013d). Reports Received and Reports Entered into AERS by Year. Retrieved August 2013, from http://www.fda.gov/Drugs/GuidanceComplianceRequiatoryInformation/Surveillance/AdverseDrugEffects/ucm070434.htm
FDA. (2013e). US Food and Drug Administration. Drug Safety and Availability: Medication Guides. Retrieved August 2013, from http://www.fda.gov/Drugs/Drugs/DrugSafety/ucm.085729.htm
FDA. (2014a). Medication Guides for Certain Prescription Products., from http://www.fda.gov/ForConsumers/ConsumerUpdatest/ucm107825.htm
FDA. (2014b). Safety: What is a Serious Adverse Event?, from http://www.fda.gov/safety/medwatch/howtoreport/ucm053087.htm
Harpaz, R., Chase, H. S., & Friedman, C. (2010). Mining multi-item drug adverse effect associations in spontaneous reporting systems. BMC Bioinformatics, 11 Suppl 9, S7. doi: 10.1186/1471-2105-11-S9-S7
Harpaz, R., DuMouchel, W., LePendu, P., Bauer-Mehren, A., Ryan, P., & Shah, N. H. (2013). Performance of pharmacovigilance signal-detection algorithms for the FDA adverse event reporting system. Clin Pharmacol Ther, 93(6), 539-546. doi: 10.1038/cIpt.2013.24
Hochberg, A. M., & Hauben, M. (2009). Time-to-signal comparison for drug safety data-mining algorithms vs. traditional signaling criteria. Clin Pharmacol Ther, 85(6), 600-606. doi: 10.1038/clpt.2009.26
Hoffman, K. B., Overstreet, B. M., & Doraiswamy, P. M. (2013). A Drug Safety ePlatform for Physicians. Pharmacists and Consumers based on Post-Marketing Adverse Events. Drugs and Therapy Studies, 3(e4).
Lasser, K. E., Allen, P. D., Woolhandler, S. J., Himmelstein, D. U., Wolfe, S. M., & Bor. D. H. (2002). Timing of new black box warnings and withdrawals for prescription medications. JAMA, 287(17), 2215-2220.
Liu, M., McPeek Hinz, E. R., Matheny, M. E., Denny, J. C., Schildcrout, J. S., Miller, R. A., & Xu, H. (2013). Comparative analysis of pharmacovigilance methods in the detection of adverse drug reactions using electronic medical records. J Am Med Inform Assoc, 20(3), 420-426. doi: 10.1136/amiajnl-2012-001119
MedDRA. (2013a). Medical Dictionary for Regulatory Activities and the Maintenance and Support Services. Retrieved February 2014, from http://www.meddramsso.com
MedDRA. (2013b). Medical Dictionary for Regulatory Activities and the Maintenance and Support Services (MedDRA). Retrieved August 2013, from http://www.meddramsso.com
Moore, T. J., Furberg, C. D., Glenmullen, J., Maltsberger, J. T., & Singh, S. (2011). Suicidal behavior and depression in smoking cessation treatments. PLoS One, 6(11), e27016. doi: 10.1371/journal.pone.0027016
Moore, T. J., Glenmullen, J., & Furberg, C. D. (2010). Prescription drugs associated with reports of violence towards others. PLoS One, 5(12).n15337. doi: 10.1371/journal.pone.0015337
Poluzzi, E., Raschi, E., Koci, A., Moretti, U., Spina, E., Behr, E. R., . . . De Ponti, F. (2)13). Antipsychotics and Torsadogenic risk: signals emerging from the US FDA Adverse Event Reporting System Database. Drug Saf, 36(6), 467-479. doi: 10.1007/s40264-013-0032-z
Robertson, H. T., & Allison, D. B. (2009). Drugs associated with more suicidal ideations are also associated with more suicide attempts. PLoS One, 4(10), e7312. doi: 10.1371/journal.pone.0007312
RxNorm. National Library of Medicine. Retrieved January 2014, from http://www.nlm.nih.gov/research/umls/rxnorm/
Sakaeda, T., Kadoyama, K., & Okuno, Y. (2011). Statin-associated muscular and renal adverse events: data mining of the public version of the FDA adverse event reporting system. PLoS One, 6(12), e28124. doi: 10.1371/journal.pone.0028124
Szarfman, A., Tonning, J. M., & Doraiswamy, P. M. (2004). Pharmacovigilance in the 21st century: new systematic tools for an old problem. Pharmacotherapy, 24(9), 1099-1104.
Takarabe, M., Kotera, M., Nishimura, Y., Goto, S., & Yamanishi, Y. (2012). Drug target prediction using adverse event report systems: a pharmacogenomic approach. Bioinformatics, 28(18), i611-i618. doi: 10.1093/bioinformatics/bts413
Tamura, T., Sakaeda, T., Kadoyama, K., & Okuno, Y. (2012). Aspirin- and clopidogrel-associated bleeding complications: data mining of the public version of the FDA adverse event reporting system, AERS. Int J Med Sci, 9(6), 441-446. doi: 10.7150/ijms.4549
van Walraven, C., Austin, P. C., Jennings, A., Quan, H., & Forster, A. J. (2009). A modification of the Elixhauser comorbidity measures into a point system for hospital death using administrative data. Med Care, 47(6), 626-633. doi: 10.1097/MLR.0b013e31819432e5
Wang, H. W., Hochberg, A. M., Pearson, R. K., & Hauben, M. (2010). An experimental investigation of masking in the US FDA adverse event reporting system database. Drug Saf, 33(12), 1117-1133. doi: 10.2165/11584390-000000000-00000
Weaver, J., Grenade, L. L., Kwon, H., & Avigan, M. (2009). Finding, evaluating, and managing drug-related risks: approaches taken by the US Food and Drug Administration (FDA). Dermatol Ther, 22(3), 204-215. doi: 10.1111/j.1529-8019.2009.01233.x

### CLAUSES

Notwithstanding the appended clauses, the disclosure is also defined by the following clauses:

1. A system for estimating the safety profile, or level of risk, associated with a given medical product or treatment, the system comprising:

memory configured to store multiple parameters derived from safety-related information for the given medical product or treatment; and a processor coupled to the memory and operable to execute programmed instructions stored in the memory, wherein the programmed instructions are configured to:

assign an individual value for one or more of various safety-related parameters, wherein the individual value or values are based on an estimated safety assessment for a patient, patient group, or population, wherein such individual value or values are combined in such a manner useful for determining a safety-related score or ranking for the medical product or treatment.

2. The system of clause 1, wherein the score or ranking is a single number, indicating a risk ascribable to the medical product or treatment.
3. The system of clause 1, wherein the score or ranking is a set of two single numbers indicating a risk ascribable to the medical treatment.
4. The system of clause 1, wherein the score or ranking is a single number combined with a letter indicating a risk ascribable to the medical product or treatment.
5. The system of clause 1, wherein the score or ranking comprises a single number, a set of two single numbers, a single number combined with a letter combined, and a color code indicating a risk ascribable to the medical product or treatment.
6. The system of any of the preceding clauses, wherein the parameters include data regarding patient Outcome, or globally comparable term, from a safety or adverse event database.
7. The system of any of the preceding clauses, wherein the parameters include data regarding Adverse Event Seriousness, or globally comparable term, from a safety or adverse event database.
8. The system of any of the preceding clauses, wherein the parameters include data regarding one or more disproportionality measures, or other related mathematical comparison, calculated from data in a safety or adverse event database.
9. The system of any of the preceding clauses, wherein the parameters include data regarding a Condition, or Indication, Seriousness, or globally comparable, classification from a safety or adverse event database.
10. The system of any of the preceding clauses, wherein the parameters include data regarding an Event Reporter, or globally comparable, classification from a safety or adverse event database.
11. The system of any of the preceding clauses, wherein the parameters include data regarding a Report Type, or globally comparable, classification from a safety or adverse event database.
12. The system of any of the preceding clauses, wherein the individual value for one or more of various safety-related parameters are subjected to an Importance Weighting factor.
13. The system of clause 12, wherein the Importance Weighting factor is higher for parameters submitted by a healthcare professional than the Importance Weighting factor for parameters submitted by a non-healthcare professional.
14. The system of clause 12, wherein the Importance Weighting factor is higher for parameters that concern safety or risk-related information for one medical product or treatment than the Importance Weighting factor for parameters that concern safety or risk-related information for more than one medical product or treatment.
15. The system of any of clauses 1 to 11, wherein the safety-related information is subjected to an Importance Weighting factor.
16. The system of clause 15, wherein the Importance Weighting factor is higher for safety-related information submitted by a healthcare professional than the Importance Weighting factor for safety-related information submitted by a non-healthcare professional.
17. The system of clause 15, wherein the Importance Weighting factor is higher for safety-related information regarding one medical product or treatment than the Importance Weighting factor for safety-related information that concern more than one medical product or treatment.
18. The system of any of the preceding clauses, wherein the parameters include data regarding a drug Schedule, or globally comparable, classification.
19. The system of any of the preceding clauses, wherein the parameters include data regarding a Medication Guide, or globally comparable, classification.
20. The system of any of the preceding clauses, wherein the parameters include data regarding a Boxed Warning, or globally comparable, classification.
21. The system of any of the preceding clauses, wherein the parameters include data regarding post-marketing safety information associated with the drug, medication, dietary supplement, or medical device.
22. The system of any of the preceding clauses, wherein the parameters include data regarding pre-marketing safety information associated with the drug, medication, dietary supplement, or medical device.

23. The system of clause 22, wherein the parameters comprise data from an adverse event, or related safety, database for drugs.

24. The system of clause 22, wherein the parameters comprise data from an adverse event, or related safety, database for dietary supplements.

25. The system of clause 22, wherein the parameters comprise data from an adverse event, or related safety, database for vaccines.

26. The system of clause 22, wherein the parameters comprise data from an adverse event, or related safety, database for medical devices.

27. The system of any of the preceding clauses, wherein the parameters comprise data from one or more international or national pharmacovigilance centers including: FAERS, Australia's “Therapeutic Goods Administration,” Canada's “Vigilance Adverse Reaction Online Database,” Europe's “EudraVigilance,” Japan's “Pharmaceuticals and Medical Devices Agency,” The United Kingdom's “Yellow Card Scheme,” France's “pharmacovigilance database (ANSM),” or The World Health Organization's “VigiBase.”

28. The system of any of the preceding clauses, wherein the parameters comprise data taken from one or more of any adverse event database(s).
29. The system of any of the preceding clauses, wherein the parameters comprise data taken from one or more safety-related database(s).
30. A method of estimating safety risks associated with the use of a medical product or treatment includes receiving safety-related information regarding adverse events, associated with a given medical product or treatment, comprising:

determining multiple parameters using such received data, the parameters being based on safety information from various sources,

assigning a predetermined estimate of the predictive value of received data with regard to a possible safety risks associated with a given medical product or treatment, and

determining a probability of the safety risk as a function of the multiple parameters.

31. The method of clause 30, wherein a value is a single number, indicating a risk ascribable to the medical product or treatment.
32. The method of any of clauses 30 or 31, wherein the parameters include data regarding patient Outcome, or globally comparable term, from an adverse event database.
33. The method of any of clauses 30 to 32, wherein the parameters include data regarding Adverse Event Seriousness, or globally comparable term, from an adverse event database.
34. The method of any of clauses 30 to 33, wherein the parameters include data regarding one or more disproportionality, or other related mathematical comparison, measures calculated from data in an adverse event database.
35. The method of any of clauses 30 to 34, wherein the parameters include data regarding Condition Seriousness as designated in an FDA database.
36. The method of any of clauses 30 to 35, wherein the parameters include data regarding Event Reporter as designated in an FDA database.
37. The method of any of clauses 30 to 36, wherein the parameters include data regarding Report Type as designated in an FDA database.
38. The method of any of clauses 30 to 37, wherein the parameters include data regarding a drugs Schedule classification as published by the Drug Enforcement Agency.
39. The method of any of clauses 30 to 38, wherein the parameters include data regarding a Medication Guide classification as published by the Food and Drug Administration.
40. The method of any of clauses 30 to 39, wherein the parameters include data regarding a boxed warning classification as published by the Food and Drug Administration.
41. The method of any of clauses 30 to 40, wherein the parameters include data regarding post-marketing safety information associated with the medical treatment.
42. The method of any of clauses 30 to 41, wherein the parameters include data regarding pre-marketing safety information associated with the medical treatment.
43. The method of any of clauses 30 to 42, wherein the parameters comprise data taken from FAERS, the FDA's adverse event database for drugs.
44. The method of any of clauses 30 to 43, wherein the parameters comprise data taken from one or more of any global adverse event database.
45. The method of any of clauses 30 to 44, wherein the parameters comprise data taken from one or more of: FAERS, Australia's “Therapeutic Goods Administration,” Canada's “Vigilance Adverse Reaction Online Database,” Europe's “EudraVigilance,” Japan's “Pharmaceuticals and Medical Devices Agency,” The United Kingdom's “Yellow Card Scheme,” France's “pharmacovigilance database (ANSM),” or The World Health Organization's “VigiBase.”
46. The method of any of clauses 30 to 42, wherein the parameters comprise data taken from CAERS, the FDA's adverse event database for dietary supplements.
47. The method of any of clauses 30 to 42, wherein the parameters comprise data taken from VAERS, the FDA's adverse event database for vaccines.
48. The method of any of clauses 30 to 42, wherein the parameters comprise data taken from MAUDE, the FDA's adverse event database for medical devices.
49. A system for estimating patient safety risks associated with a given medical product or treatment includes memory configured to store received data regarding the given medical product or treatment and a processor coupled to the memory and operable to execute programmed instructions, wherein the programmed instructions are configured to differentially weight various parameters associated with each medical product or treatment to produce a probability safety risk score as a function of such parameters.
50. A system for surveillance, ranking, scoring, and analyzing medical product or treatment safety-related information comprising: at least one database containing information about adverse events associated with medical products or treatments, wherein the information about the adverse events includes safety-related information comprises a plurality of potential risks to a patient; a first processor configured to assign pre-determined values for one or multiple risk parameters regarding an adverse event; a second processor configured to determine an initial risk valuation score or ranking based upon the output of the first processor, a third processor configured to optionally modify the initial risk valuation score or ranking based on pre-determined user-inputted qualifiers; and a forth processor to translate the output from processor three into a final ranking or score.
51. The system of any of clauses 49 to 50, wherein the score or ranking is a single number, indicating a risk ascribable to the medical product or treatment.
52. The system of any of clauses 49 to 50, wherein the score or ranking is a set of two single numbers indicating a risk ascribable to the medical treatment.
53. The system of any of clauses 49 to 50, wherein the score or ranking is a single number combined with a letter indicating a risk ascribable to the medical product or treatment.
54. The system of any of clauses 49 to 50, wherein the score or ranking comprises a single number, a set of two single numbers, a single number combined with a letter combined, and a color code indicating a risk ascribable to the medical product or treatment.
55. The system of any of clauses 49 to 54, wherein the parameters include data regarding patient Outcome, or globally comparable term, from a safety or adverse event database.
56. The system of any of clauses 49 to 55, wherein the parameters include data regarding Adverse Event Seriousness, or globally comparable term, from a safety or adverse event database.
57. The system of any of clauses 49 to 56, wherein the parameters include data regarding one or more disproportionality or other related mathematical comparison, measures calculated from data in a safety or adverse event database.
58. The system of any of clauses 49 to 57, wherein the parameters include data regarding a Condition Seriousness, or globally comparable, classification from a safety or adverse event database.
59. The system of any of clauses 49 to 58, wherein the parameters include data regarding an Event Reporter, or globally comparable, classification from a safety or adverse event database.
60. The system of any of clauses 49 to 59, wherein the parameters include data regarding a Report Type, or globally comparable, classification from a safety or adverse event database.
61. The system of any of clauses 49 to 58, wherein the individual value for one or more of various safety-related parameters are subjected to an Importance Weighting factor.
62. The system according to clause 59, wherein the individual value for one or more of various safety-related parameters are subjected to an Importance Weighting factor.
63. The system according to clause 60, wherein the individual value for one or more of various safety-related parameters are subjected to an Importance Weighting factor.
64. The system of clause 61, wherein the Importance Weighting factor is higher for parameters submitted by a healthcare professional than the Importance Weighting factor for parameters submitted by a non-healthcare professional.
65. The system of clause 61, wherein the Importance Weighting factor is higher for parameters that concern safety or risk-related information for one medical product or treatment than the Importance Weighting factor for parameters that concern safety or risk-related information for more than one medical product or treatment.
66. The system of any of clauses 49 to 60, wherein the safety-related information is subjected to an Importance Weighting factor.
67. The system of clause 66, wherein the Importance Weighting factor is higher for safety-related information submitted by a healthcare professional than the Importance Weighting factor for safety-related information submitted by a non-healthcare professional.
68. The system of clause 66, wherein the Importance Weighting factor is higher for safety-related information regarding one medical product or treatment than the Importance Weighting factor for safety-related information that concern more than one medical product or treatment.
69. The system of any of clauses 49 to 68, wherein the parameters include data regarding a drug Schedule, or globally comparable, classification.
70. The system of any of clauses 49 to 69, wherein the parameters include data regarding a Medication Guide, or globally comparable, classification.
71. The system of any of clauses 49 to 70, wherein the parameters include data regarding a Boxed Warning, or globally comparable, classification.
72. The system of any of clauses 49 to 71, wherein the parameters include data regarding post-marketing safety information associated with the drug, medication, dietary supplement, or medical device.
73. The system of any of clauses 49 to 72, wherein the parameters include data regarding pre-marketing safety information associated with the drug, medication, dietary supplement, or medical device.
74. The system of clause 73, wherein the parameters comprise data from an adverse event, or related safety, database for drugs.
75. The system of clause 73, wherein the parameters comprise data from an adverse event, or related safety, database for dietary supplements.
76. The system of clause 73, wherein the parameters comprise data from an adverse event, or related safety, database for vaccines.
77. The system of clause 73, wherein the parameters comprise data from an adverse event, or related safety, database for medical devices.
78. The system of any of clauses 49 to 77, wherein the parameters comprise data from one or more international or national pharmacovigilance centers including: FAERS, Australia's “Therapeutic Goods Administration,” Canada's “Vigilance Adverse Reaction Online Database,” Europe's “EudraVigilance,” Japan's “Pharmaceuticals and Medical Devices Agency,” The United Kingdom's “Yellow Card Scheme,” France's “pharmacovigilance database (ANSM),” or The World Health Organization's “VigiBase.”
79. The system of any of clauses 49 to 78, wherein the parameters comprise data taken from one or more of any adverse event database(s).
80. The system of any of clauses 49 to 79, wherein the parameters comprise data taken from one or more safety-related database(s).
81. A system for scoring or ranking a member, select members, or all members of the drugs, vaccines, medications, dietary supplements, or medical devices a subject is using comprising: at least one database containing safety-related information, wherein the information about the safety-related information comprises a plurality of potential risks to a patient; a first processor configured to assign pre-determined values for one or multiple risk parameters; a second processor configured to determine an initial risk valuation score or ranking based upon the output of the first processor, a third processor configured to optionally modify the initial risk valuation score or ranking based on pre-determined user-inputted qualifiers such as their comorbidity burden; a forth processor configured to translate the output from processor three into a final ranking or score; a fifth processor configured to determine if there are any replacement drugs, vaccines, medications, dietary supplements, or medical devices within each respective category that might be used to replace any drugs, vaccines, medications, dietary supplements, or medical devices that have high risk scores as outputted from processor four; and a sixth processor configured to recalculated scores in response to the potential changes or substitutions from processor five.
82. A system for scoring or ranking a member, select members, or all members of the drugs, vaccines, or medications listed in a formulary or similar prescribing guidance document comprising: at least one database containing safety-related information, wherein the information about the safety-related information comprises a plurality of potential risks; a first processor configured to assign pre-determined values for one or multiple risk parameters; a second processor configured to determine an initial risk valuation score or ranking based upon the output of the first processor, a third processor configured to optionally modify the initial risk valuation score or ranking based on pre-determined user-inputted qualifiers such as comorbidity burdens typical encountered by subjects who take the drugs, vaccines, or medications listed in the formulary or similar prescribing guidance document; a forth processor configured to translate the output from processor three into a final ranking or score; a fifth processor configured to determine if there are any replacement drugs, vaccines, or medications, within each respective category that might be used to replace any drugs, vaccines, or medications that have high risk scores as outputted from processor four; and a sixth processor configured to recalculated scores in response to the potential changes or substitutions from processor five.
83. A system for evaluating safety-related risk associated with a medical product or treatment, the system comprising: memory configured to store one or more safety or risk-related event observations for the medical product or treatment; and a processor coupled to the memory and operable to execute programmed instructions stored in the memory, wherein the programmed instructions are configured to: determine a safety or risk parameter value using the safety or risk-related event observation for the medical product or treatment, wherein the safety or risk parameter is based on an estimate of a increase in a predictive value of the safety or risk-related event observation with regard to a possible adverse event associated with the medical product or treatment; determine a safety or risk parameter value using a safety or risk status observation for the medical product or treatment, wherein the safety or risk parameter is based on an estimate of a increase in the predictive value of the safety or risk status observation with regard to the possible adverse event associated with the medical product or treatment; and determine a score or ranking regarding the adverse event as a function of the safety or risk parameters.
84. The system of clause 83, wherein determining the safety or risk parameters includes using a mathematical model to determine the safety or risk parameters, and wherein the mathematical model includes a plurality of predetermined safety or risk parameters.
85. The system of clause 83, wherein the medical product or treatment is a pharmacological intervention.
86. A system for evaluating safety-related risk associated with a medical product or treatment, the system comprising: memory configured to store received data regarding the medical product or treatment; and a processor coupled to the memory and operable to execute programmed instructions stored in the memory, wherein the programmed instructions are configured to: determine a parameter using the received data to select the parameter from a plurality of predetermined parameters included in a mathematical model, wherein the parameter is based on an estimate of a predictive value of the received data with regard to a possible safety-related or adverse event associated with the medical product or treatment, and wherein the plurality of predetermined parameters are generated by sampling at least one of a safety or risk-related event from a plurality of safety or risk-related parameters associated with the medical product or treatment, and by assigning a value to one of more of the plurality of safety or risk-related parameters associated with the medical product or treatment in order to estimate the predictive value of the safety or risk-related parameters; and determining a score or ranking of the safety or risk-related parameters as a function of the parameters.
87. A medical product or treatment safety scoring system, comprising: a computer system having a processor that supports operation of a software application, wherein the computer system is configured to receive safety-related medical product or treatment information, and to communicate the safety-related information to a filter module; a data storage module, accessed on the computer system, including a plurality of safety-related data records obtained from at least one of a safety-related information database; the filter module, executed on the computer system, comprising: a first filter for obtaining relevant medical product or treatment safety-related data from the data storage module's plurality of safety-related data records; a second filter for comparing the obtained safety-related data of a specific medical product or treatment to the obtained safety-related data of comparison medical products or treatments and assigning a numerical value to at least one of the factors comprising the relevant safety-related data; and a third filter for weighting and combining the numerical values of the relevant safety-related data into a safety score for the specific medical product or treatment, wherein weighting is determined by a modeling technique applied to the plurality of data records, wherein combining comprises adding the weighted numerical values; and an output module for reporting an indication of the safety score to a user, wherein the indication of the safety score is one of a number and a range of numbers from a preselected scale, wherein the preselected scale is 1 to 100.
88. A method of using a system according to any of clauses 49 to 87.

The foregoing disclosures regarding preferred embodiments of the present invention has been presented for purposes of illustration and description. It is not intended to be exhaustive, nor to limit the invention to the precise depictions disclosed herein. Multiple modifications, variations, and extrapolations from the embodiments described herein will be apparent to one with ordinary skill in the art. The scope of the invention is to be defined only by the claims appended hereto, and by their equivalents.

In describing representative embodiments of the present invention, the specification may have presented the method, process, or steps as a particular sequence. However the method or process need not be limited to the particular sequence of steps described. As one of ordinary skill in the art would appreciate, other sequences of methods, processes, or steps may be possible. Therefore, the particular order of the methods, processes, or steps set forth in the specification should not be construed as limitations on the claims as one with skill in the art can readily appreciate that the methods, processes, or steps may be modified yet still remain within both the scope and spirit of the present invention. Finally, it is envisioned that the concepts taught herein could be applied to the surveillance, scoring, ranking or indicating of any program where it is desirable to monitor safety-related events.

1. A system for estimating a safety profile for a medical intervention for a patient, the system comprising:
a memory configured to store multiple safety-related parameters derived from safety-related information for the given medical intervention; and
a processor coupled to the memory and operable to execute programmed instructions stored in the memory, wherein the programmed instructions are configured to:
assign an individual value for one or more of the safety-related parameters; and
output a safety related score for the medical intervention from the one or more individual values.

2. The system according to claim 1, wherein the medical intervention is a pharmacological intervention.

3. The system according to claim 2, wherein the safety related score is a single number.

4. The system according to claim 1, wherein the safety-related parameters comprise data regarding Patient Outcome, or globally comparable term, from a safety or adverse event database.

5. The system according to claim 1, wherein the safety-related parameters comprises data regarding Adverse Event Seriousness, or globally comparable term, from a safety or adverse event database.

6. The system according to claim 1, wherein the safety-related parameters comprise data regarding one or more disproportionality measures, or other related mathematical comparison, calculated from data in a safety or adverse event database.

7. The system according to claim 1, wherein the safety-related parameters comprise data regarding a Condition Seriousness, or globally comparable, classification from a safety or adverse event database.

8. The system according to claim 1, wherein the safety-related parameters comprise data regarding a Report Type, or globally comparable, classification from a safety or adverse event database.

9. The system according to claim 1, wherein the individual value comprises an Importance Weighting factor component.

10-11. (canceled)

12. The system according to claim 1, wherein the safety-related parameters comprise data regarding a drug Schedule, or globally comparable, classification.

13. The system according to claim 1, wherein the safety-related parameters comprise data regarding a Medication Guide, or globally comparable, classification.

14. The system according to claim 1, wherein the safety-related parameters comprise data regarding a Boxed Warning, or globally comparable, classification.

15. The system according to claim 1, wherein the safety-related parameters comprise data regarding post-marketing safety information associated with the drug, medication, dietary supplement, or medical device.

16. The system according to claim 1, wherein the safety-related parameters comprise data regarding pre-marketing safety information associated with the drug, medication, dietary supplement, or medical device.

17. The system according to claim 1, wherein the safety related parameters comprise data from an adverse event, or related safety, database for drugs.

18. The system according to claim 1, wherein the safety-related parameters comprise data from one or more pharmacovigilance centers.

19. (canceled)

20. The system according to claim 18, wherein the data has been subjected to a filtering protocol.

21. The system according to claim 20, wherein the filtering protocol is configured to perform one or more tasks selected from the group consisting of: automated name matching to correct for drug name misspellings and incorrect data; aggregation of generic and non-United States brand name drugs under a single brand name; separation of primary suspect and all suspect designations; removal of duplicate case reports; and identification of common adverse event and condition types.

22. The system according to claim 1, wherein the system is configured to output a safety related score for two or more medical interventions.

23. The system according to claim 22, wherein the two or more medical interventions are medical interventions that treat the same condition.

24. (canceled)

25. A method for estimating a safety profile for a medical intervention for a patient, the method comprising:
(a) inputting an identifier of the medical intervention into a safety profile estimating system comprising:
a memory configured to store multiple safety-related parameters derived from safety-related information for the given medical intervention; and
a processor coupled to the memory and operable to execute programmed instructions stored in the memory, wherein the programmed instructions are configured to:
assign an individual value for one or more of the safety-related parameters; and
output a safety related score for the medical intervention from the one or more individual values; and
(b) obtaining from the safety profile estimating system a safety related score for the medical intervention.

26-48. (canceled)

49. A system for filtering data from a pharmacovigilance center database, the system comprising:
a memory configured to store data from a pharmacovigilance center database; and
a processor coupled to the memory and operable to execute programmed instructions stored in the memory, wherein the programmed instructions are configured to:
filter the data according to a filtering protocol, wherein the filtering protocol is configured to perform one or more tasks selected from the group consisting of: automated name matching to correct for drug name misspellings and incorrect data; aggregation of generic and non-United States brand name drugs under a single brand name; separation of primary suspect and all suspect designations; removal of duplicate case reports; and identification of common adverse event and condition types; and
output a filtered dataset.

50-52. (canceled)
